(19) United States
(12) Patent Application Publication
(10) Pub. No.: US 2023/0291525 A1
(43) Pub. Date: Sep. 14, 2023

(54) ACTIVATION OF JOINT DL/UL TCI STATES FOR MDCI

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US)

(21) Appl. No.: 18/019,236

(22) PCT Filed: Sep. 8, 2021
(86) PCT No.: PCT/CN2021/117220

§ 371 Date: Feb. 1, 2023

(30) Foreign Application Priority Data
Sep. 9, 2020 (WO) PCT/CN2020/114161
Sep. 9, 2020 (WO) PCT/CN2020/114177

(51) Int. Cl. H04L 5/00; H04W 72/20

(52) U.S. Cl. CPC H04L 5/0053; H04W 72/20

(57) ABSTRACT

Aspects presented herein relate to methods and devices for wireless communication including an apparatus, e.g., a UE and/or a TRP or base station. In one aspect, the apparatus may receive, from a TRP, a MAC-CE activating a subset of configured joint DL and UL TCI states, each activated joint DL and UL TCI state indicating a common beam for communication in DL and UL, the MAC-CE indicating a CORESET pool ID associated with a set of CORESETs. Additionally, the apparatus may communicate with the TRP through DL and UL scheduled through one or more CORESETs of the set of CORESETs associated with the CORESET pool ID based on the activated joint DL and UL TCI states.

### CROSS REFERENCE TO RELATED APPLICATION(S)

This application claims the benefit of International Patent Application No. PCT/CN2020/114177, entitled “METHODS AND APPARATUS FOR ACTIVATION OF JOINT DL/UL TCI STATES FOR MDCI” and filed on Sep. 9, 2020, and International Patent Application No. PCT/CN2020/114161, entitled “ACTIVATION OF JOINT DL/UL TCI STATE FOR SINGLE DCI AND MULTIPLE TRPS” and filed on Sep. 9, 2020, each of which is expressly incorporated by reference herein in its entirety.

### TECHNICAL FIELD

The present disclosure relates generally to communication systems, and more particularly, to activation of joint downlink (DL) and uplink (UL) transmission configuration indicator (TCI) states using a media access control (MAC) control element (CE) (MAC-CE) in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced (pc)mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. The apparatus may also receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states and indicating which of the at least one of the PUCCH, the PUSCH, the SRS, or the PRACH for UL that is scheduled by a CORESET associated with the CORESET pool ID is applicable to each of the activated joint DL and UL TCI states. The apparatus may also receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID. Additionally, the apparatus may receive an indication of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication. The apparatus may also determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID. The apparatus may also communicate with the TRP through DL and UL scheduled through one or more CORESETs of the set of CORESETs associated with the CORESET pool ID based on the activated joint DL and UL TCI states, the activated DL TCI states, or the activated UL TCI states.

In another aspect of the disclosure, a method, a computer-readable medium, and an apparatus are provided. The apparatus may be a transmission reception point (TRP) or a base station. The apparatus may transmit, to a user equipment (UE), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. The apparatus may also transmit a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states. The apparatus may also transmit downlink control information (DCI) in a CORESET associated with the CORESET pool ID, the DCI indicating an index of a TCI codepoint, the index corresponding to one of the activated joint DL and UL TCI states associated with the CORESET pool ID. Further, the apparatus may transmit an indication of DL resources and UL resources for communication scheduled by one or more CORESETs associated with the CORESET pool ID, where the DL resources and the UL resources for the communication scheduled by the one or more CORESETs associated with the CORESET pool ID are based on the transmitted indication. The apparatus may also communicate with the UE through DL and UL scheduled through one or more CORESETs of the set of CORESETs associated with the CORESET pool ID based on the activated joint DL and UL TCI states, the activated DL TCI states, or the activated UL TCI states.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a call-flow diagram illustrating activation of joint DL/UL TCI states in association with a single scheduling DCI from one TRP scheduling a UE with DL/UL with multiple TRPs.

FIG. 5 is a diagram illustrating a MAC-CE for activating joint DL/UL TCI states and DL/UL communication with multiple TRPs.

FIG. 6 is a diagram illustrating an example MAC-CE.

FIG. 7 is a diagram illustrating example communication between a UE and a TRP or base station.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a diagram illustrating an example of a hardware implementation for an example apparatus.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

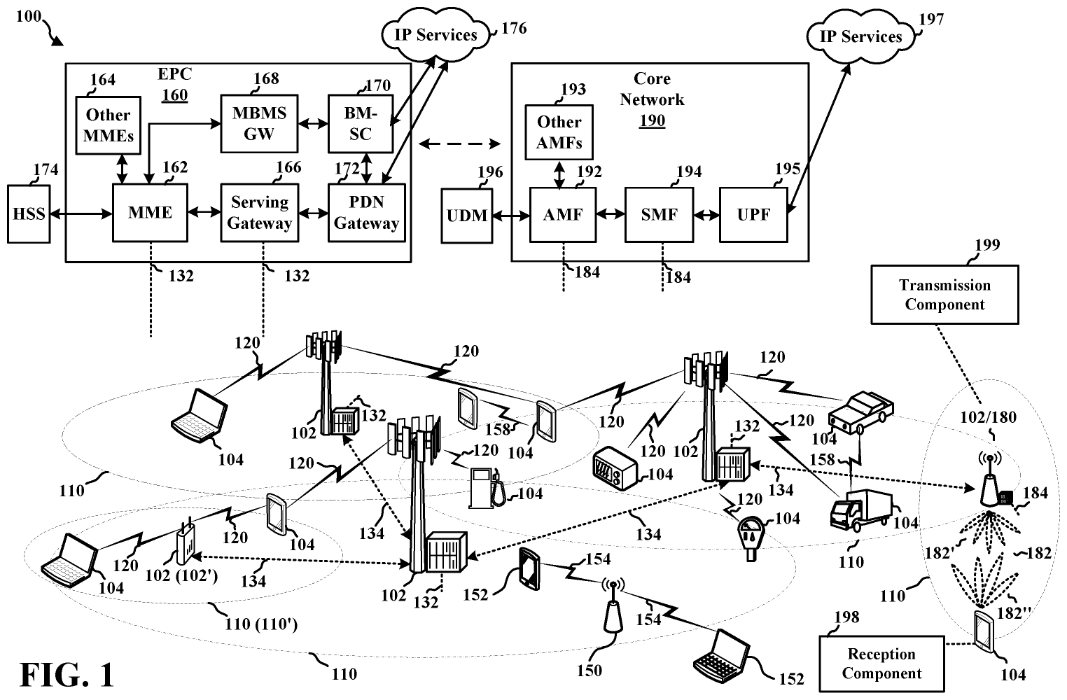

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a reception component 198 configured to receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. Reception component 198 may also be configured to receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states and indicating which of the at least one of the PUCCH, the PUSCH, the SRS, or the PRACH for UL that is scheduled by a CORESET associated with the CORESET pool ID is applicable to each of the activated joint DL and UL TCI states. Reception component 198 may also be configured to receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID. Reception component 198 may also be configured to receive an indication of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication. Reception component 198 may also be configured to determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID. Reception component 198 may also be configured to communicate with the TRP through DL and UL scheduled through one or more CORESETs of the set of CORESETs associated with the CORESET pool ID based on the activated joint DL and UL TCI states, the activated DL TCI states, or the activated UL TCI states.

Referring again to FIG. 1, in certain aspects, the base station 180 may include a transmission component 199 configured to transmit, to a user equipment (UE), a media access control (MAC) control element (CE) (MAC-CE) activating a subset of configured joint downlink (DL) and uplink (UL) transmission configuration indicator (TCI) states, each activated joint DL and UL TCI state indicating a common beam for communication in DL and UL, the MAC-CE indicating a control resource set (CORESET) pool identifier (ID) associated with a set of CORESETs. Transmission component 199 may also be configured to transmit a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states. Transmission component 199 may also be configured to transmit downlink control information (DCI) in a CORESET associated with the CORESET pool ID, the DCI indicating an index of a TCI codepoint, the index corresponding to one of the activated joint DL and UL TCI states associated with the CORESET pool ID. Transmission component 199 may also be configured to transmit an indication of DL resources and UL resources for communication scheduled by one or more CORESETs associated with the CORESET pool ID, where the DL resources and the UL resources for the communication scheduled by the one or more CORESETs associated with the CORESET pool ID are based on the transmitted indication. Transmission component 199 may also be configured to communicate with the UE through DL and UL scheduled through one or more CORESETs of the set of CORESETs associated with the CORESET pool ID based on the activated joint DL and UL TCI states.

Although the following description may be focused on 5G NR, the concepts described herein may be applicable to other similar areas, such as LTE, LTE-A, CDMA, GSM, and other wireless technologies.

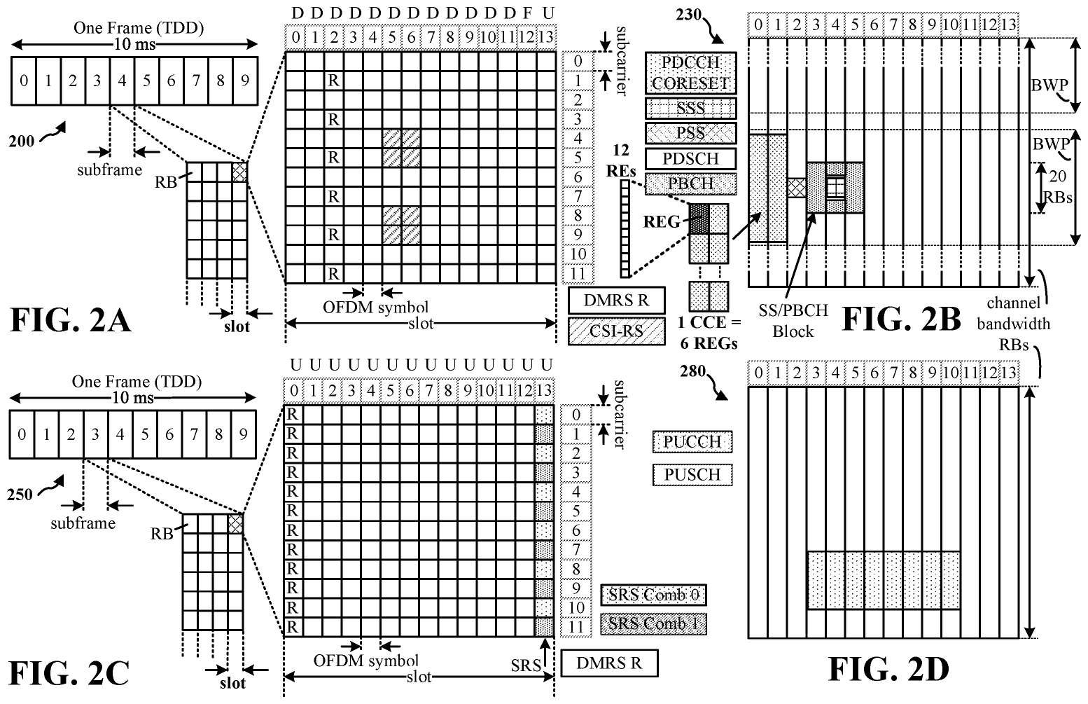

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) ACK/NACK feedback. The PUSCH carries data, and may additionally be used to carry a buffer status report (BSR), a power headroom report (PHR), and/or UCI.

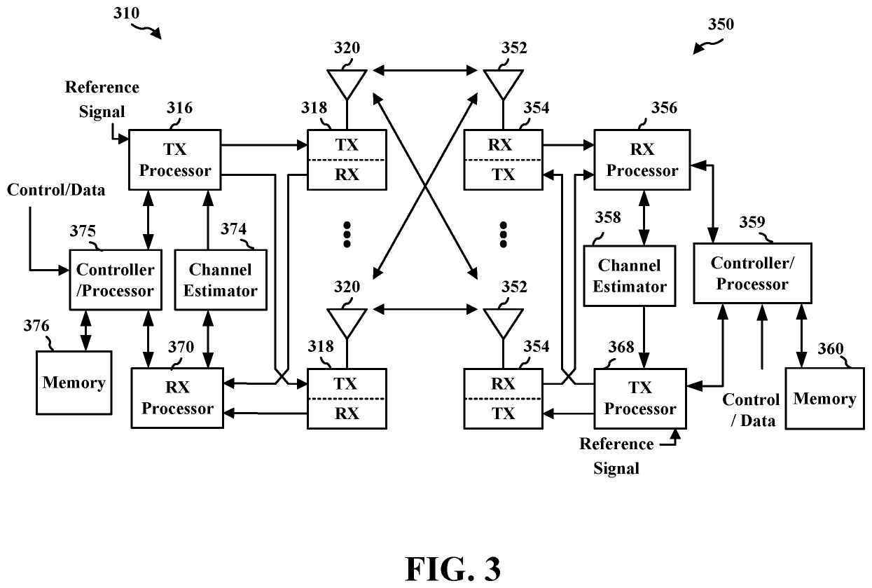

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

In some aspects of wireless communications, it may be beneficial to provide an enhancement on multi-beam operation, mainly targeting frequency range 2 (FR2) while also applicable to frequency range 1 (FR1). To enhance multi-beam operation, features may be identified and specified to facilitate more efficient (lower latency and overhead) DL/UL beam management to support higher intra and L1/L2-centric inter-cell mobility and/or a larger number of configured TCI states. A common beam for data and control transmission/reception for DL and UL, especially for intra-band carrier aggregation (CA), may be specified in order to provide a unified TCI framework for DL and UL beam indication. Enhancement on signaling mechanisms for the above features to improve latency and efficiency with more usage of dynamic control signaling (as opposed to RRC) may be provided. Further, features may be identified and specified to facilitate UL beam selection for UEs equipped with multiple panels, considering UL coverage loss mitigation due to maximum permissible exposure (MPE), based on UL beam indication with the unified TCI framework for UL fast panel selection.

Additionally, a unified TCI framework for DL and UL beam indication may be needed. A major use case may be to signal a common beam for multiple DL and UL resources to save both beam indication and overhead latency. The common beam indication may be signaled via a joint DL/UL TCI state. The activation of a joint DL/UL TCI state in case of a single DCI scheduling DL/UL with multiple TRPs is described infra.

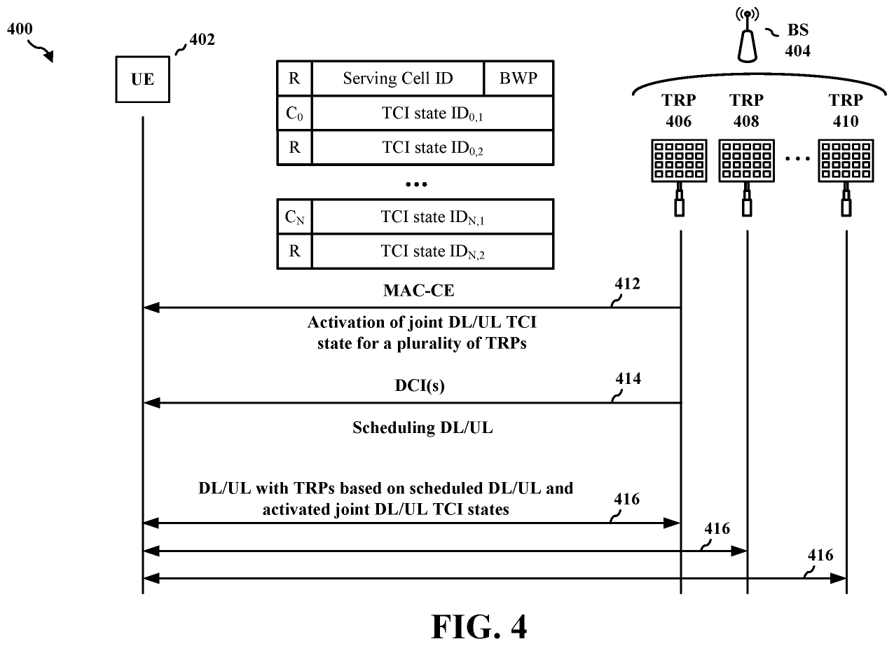

FIG. 4 is a call-flow diagram 400 illustrating activation of joint DL/UL TCI states in association with a single scheduling DCI 414 from one TRP 406 scheduling a UE 402 with DL/UL with multiple TRPs 406, 408, 410 of the base station (BS) 404. The UE 402 receives, from a TRP 406, a MAC-CE 412 activating at least one set of joint DL/UL TCI states for a plurality of TRPs (e.g., two or more of 406, 408, 410). In one example, the plurality of TRPs includes TRP 406 and at least one additional TRP 408, 410. Each activated joint DL/UL TCI state indicates a common beam (receive (Rx)/transmit (Tx) beam) for communication in DL/UL. The UE 402 receives, from the TRP 406, one or more DCIs 414 scheduling the communication through the DL/UL with the plurality of TRPs 406, 408, and/or 410. The UE 402 communicates 416 through the scheduled DL/UL with the plurality of TRPs 406, 408, and/or 410 based on the activated joint DL/UL TCI states. Although TRP 406 is used as example here, the MAC-CE 412 or DCI 414 may be transmitted from any of other TRPs, e.g., TRP 408 or 410 which are associated with BS 404.

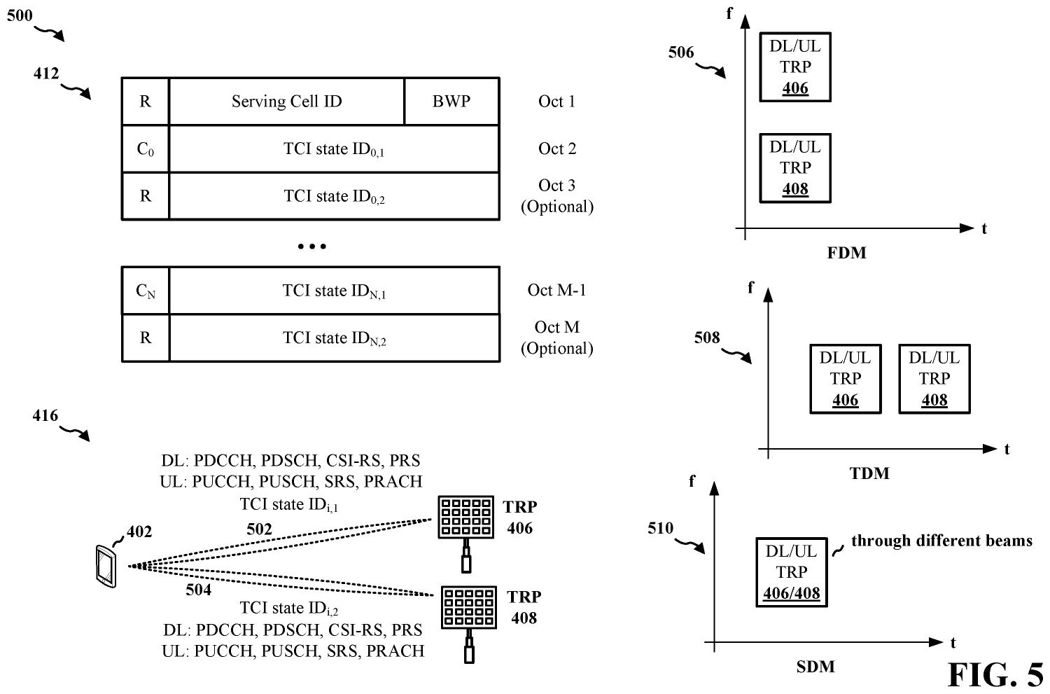

FIG. 5 is a diagram 500 illustrating a MAC-CE 412 for activating joint DL/UL TCI states and DL/UL communication 416 with multiple TRPs 406, 408. The MAC-CE 412 may be a UE-specific MAC-CE for enhanced TCI state activation/deactivation, which is transmitted on PDSCH from BS 404 to UE 402. The enhanced TCI state activation/deactivation for UE-specific MAC-CE is identified by a MAC PDU subheader. The MAC-CE 412 may have a variable size bitmap including a serving cell ID field, a BWP ID field, a Cᵢ field, TCI state ID_{i,j} field, and a reserved (R) field. The serving cell ID may indicate the identity of the serving cell for which the MAC-CE 412 applies in the case of carrier aggregation (CA). The MAC-CE 412 may activate the TCI states for any of data channel such as PDSCH, PUSCH, or control channel such as control resource set (CORESET), PUCCH, or RS signal such as CSI-RS and SRS for UE 402. The length of the field may be 5 bits, for example. The BWP ID indicates a DL BWP for which the MAC-CE 412 applies as the codepoint. The length of the BWP ID field may be 2 bits, for example. The Cᵢ field indicates whether the octet containing TCI state ID_{i,2} is present for the i^{th} TCI codepoint (i=0, . . . , N). If this field is set to “1”, the octet containing TCI state ID_{i,2} is present. If this field is set to “0”, the octet containing TCI state ID_{i,2} is not present. The TCI state ID_{i,j} field indicates the TCI state, where i is the index of the codepoint and TCI state ID_{i,j} denotes the j^{th} TCI state indicated for the i^{th} codepoint. The TCI codepoint to which the TCI states are mapped is determined by its ordinal position among all the TCI codepoints with sets of TCI state ID_{i,j} fields, i.e., the first TCI codepoint with TCI state ID_{0,1} and TCI state ID_{0,2} is mapped to the codepoint value 0, the second TCI codepoint with TCI state ID_{1,1} and TCI state ID_{1,2} is mapped to the codepoint value 1, and so on. The TCI state ID_{i,2} may be optional based on the indication of the Cᵢ field. The maximum number of activated TCI codepoints may be 8 (accordingly, N≤7) and the maximum number of TCI states mapped to a TCI codepoint may be 2. In one configuration, the maximum number of TCI states mapped to a TCI codepoint may greater than 2. When the number of TCI states mapped to a TCI codepoint is M>2 (TCI state ID_{i,m}, m=1, . . . , M), there may be a number of M−1 Cᵢ field for a TCI codepoint, respectively indicating that whether each of the TCI state ID_{i,m} is present or not, where m=2, . . . , M. The R field is a reserved bit that may be set to “0”.

In case of single-DCI based multi-TRP, one TRP may schedule DL receptions or UL transmissions simultaneously with each of multiple TRPs by sending a single scheduling DCI. In this case, the corresponding activation MAC-CE may activate at least one set of at least one joint DL/UL TCI state. At least in case of a single activated set, each of the multiple activated joint DL/UL TCI states may be sequentially applied to DL receptions or UL transmissions associated with each of the multiple scheduled TRPs. For example, if a MAC-CE activates the 0^{th} set with two joint DL/UL TCI states, the two joint TCI states are 1-to-1 mapped to two TRPs scheduled by all scheduling DCIs, where the channel types or resources of DL receptions or UL transmissions per scheduled TRP is dynamically indicated in each scheduling DCI. The channel types or resources for DL receptions associated with a TRP may be such as PDSCH, PDCCH or COREST, CSI-RS, and the channel types or resources for UL transmission associated with a TRP may be such as PUSCH, PUCCH, SRS, or PRACH. Therefore, each scheduling DCI may not have a field of TCI codepoint and may not need to specify the used joint TCI state for channel types or resources of DL receptions or UL transmissions per scheduled TRP. Resources for DL receptions or UL transmissions with multiple scheduled TRPs may be frequency division multiplexed (FDMed), time division multiplexed (TDMed), or spatially division multiplexed (SDMed), which may be dynamically indicated in each scheduling DCI. For example, a 1^{st} scheduling DCI schedules two FDMed PDSCHs with two TDMed PUCCHs associated with two TRPs, and a 2^{nd} scheduling DCI schedules two TDMed PUSCHs associated with two TRPs. For both scheduling DCIs, the two joint TCI states in the 0^{th} set activated by the MAC-CE may be applied to resources allocated for DL receptions or UL transmissions associated with the two TRPs, respectively. For example, 1^{st} joint TCI states may be applied to 1^{st} PDSCH in two FDMed PDSCHs, 1^{st} PUCCH in two TDMed PUCCHs, and 1^{st} PUSCH in two TDMed PUSCHs, and similarly, 2^{nd} joint TCI states may be applied to 2^{nd} PDSCH in two FDMed PDSCHs, 2^{nd} PUCCH in two TDMed PUCCHs, and 2^{nd} PUSCH in two TDMed PUSCHs. The mapping between joint TCI state and resources of DL receptions or UL transmissions associated with each TRP may be determined in the specification (i.e., predetermined) or dynamically by BS 404 via RRC/MAC-CE/DCI.

If multiple sets of joint TCI state(s) are activated by the MAC-CE, e.g., N+1 sets and N>0, a DCI may further indicate a TCI codepoint which is mapped to one of the multiple sets of joint TCI state(s). In a first configuration, the indicated TCI codepoint may be used for resources of DL receptions or UL transmissions scheduled by the same DCI indicating the TCI codepoint. For example, 1^{st}/2^{nd} joint TCI states may be applied to 1^{st}/2^{nd} PDSCH and 1^{st}/2^{nd} PUCCH scheduled by this DCI, respectively. In a second configuration, the indicated TCI codepoint may be used for DL receptions or UL transmissions scheduled by all the following scheduling DCIs. For example, a first DCI may indicate one TCI codepoint which is mapped to a set of 1^{st} and 2^{nd} joint TCI states, and 1^{st}/2^{nd} joint TCI states may be applied to resources of DL receptions or UL transmissions for 1^{st}/2^{nd} TRPs scheduled by all the scheduling DCIs following the first DCI. Within the multiple TCI codepoints corresponding to multiple activated sets of joint DL/UL TCI states, one TCI codepoint may be defined to indicate a set of default common beams, e.g., the TCI codepoint with lowest/highest codepoint ID, at least when no TCI codepoint is indicated by any DCI.

Referring again to FIGS. 4, 5, as discussed supra, for single-DCI based multi-TRP, one TRP may schedule DL/UL communication 416 simultaneously with each of multiple TRPs by sending a single scheduling DCI 414. In this case, the corresponding activation MAC-CE 412 may activate at least one set (e.g., the 0^{th} set C₀) of at least one joint DL/UL TCI state. At least in case of a single activated set, each of the multiple activated joint DL/UL TCI states may be sequentially applied to the scheduled DL/UL communication associated with each of the multiple scheduled TRPs. For example, if the MAC-CE 412 activates the 0^{th} set C₀ with two joint DL/UL TCI states (i.e., TCI state ID_{0,1} and TCI state ID_{0,2}), the two joint DL/UL TCI states may be 1-to-1 mapped to two TRPs scheduled by all scheduling DCIs 414, where the channel types/resources of DL reception or UL transmissions per scheduled TRP is dynamically indicated in each scheduling DCI 414. For another example, if the MAC-CE activates an i^{th} set (see FIG. 5), where 0≤i≤N, the joint TCI state associated with the TCI state ID_{i,1} (which indicates a common beam direction 502 for the receive/transmit beams) may be used for receiving one or more of scheduled PDCCH, PDSCH, CSI-RS, or positioning reference signals (PRS) from the TRP 406 and for transmitting one or more of scheduled PUCCH, PUSCH, SRS, or a physical random access channel (PRACH) to the TRP 406, and the joint TCI state associated with the TCI state ID_{i,2} (which indicates a common beam direction 504 for the receive/transmit beams) may be used for receiving one or more of scheduled PDCCH, PDSCH, CSI-RS, or PRS from the TRP 408 and for transmitting one or more of scheduled PUCCH, PUSCH, SRS, or PRACH to the TRP 408. Resources for DL reception or UL transmission with multiple scheduled TRPs may be FDMed 506, TDMed 508, or SDMed 510, which may be dynamically indicated in each scheduling DCI 414. For example, a first scheduling DCI 414 may schedule two FDMed PDSCHs and two TDMed PUCCHs associated with two TRPs 406, 408, and a second scheduling DCI 414 may schedule two TDMed PUSCHs associated with the same two TRPs 406, 408. Assuming the MAC-CE activates an i^{th} set, for both scheduling DCIs 414, the two joint DL/UL TCI states in the i^{th} set activated by the MAC-CE 412 may be applied to resources allocated to the two TRPs 406, 408, respectively. For example, the joint DL/UL TCI state corresponding to the TCI state ID_{i,1} may be applied to the first PDSCH, the first PUCCH, and the first PUSCH from/to the TRP 406, while the joint DL/UL TCI state corresponding to the TCI state ID_{i,2} may be applied to the second PDSCH, the second PUCCH, and the second PUSCH from/to the TRP 408. The mapping between joint TCI state and the resources per TRP may be determined in the specification (i.e., predetermined) or dynamically by BS 404 via RRC/MAC-CE/DCI.

If multiple sets of joint TCI state(s) are activated by the MAC-CE, e.g., N+1 sets, a DCI may further indicate a TCI codepoint mapped to each set. In a first configuration, the indicated TCI codepoint (e.g., one of the sets C₀, C₁, . . . , C_{N}) may be used for DL reception or UL transmission scheduled by the same DCI 414 indicating the TCI codepoint. For example, if the DCI indicates TCI codepoint value i, where 0≤i≤N, the joint DL/UL TCI state associated with the TCI state ID_{i,1} may be applied to the first PDSCH from (Rx beam direction 502) and the first PUCCH to (Tx beam direction 502) the TRP 406 scheduled by the DCI 414, and the TCI state ID_{i,2} may be applied to the second PDSCH from (Rx beam direction 504) and the second PUCCH to (Tx beam direction 504) the TRP 408 scheduled by the DCI 414. In a second configuration, the indicated TCI codepoint may be used for DL reception or UL transmission scheduled by all the following scheduling DCIs 414. For example, the first and second joint DL/UL TCI states corresponding to TCI state ID_{i,1} and TCI state ID_{i,2}, respectively, may be applied to resources for the first TRP 406 and the second TRP 408, respectively, scheduled by separately (e.g., subsequently) received scheduling DCIs 414. Within the multiple TCI codepoints corresponding to multiple activated sets of joint DL/UL TCI states, one TCI codepoint may be defined to indicate a set of default common beams. The default common beams are applied when there is no TCI state indication for the scheduled DL receptions or UL transmissions. The common beam may be used for any of data channel such as PDSCH, PUSCH, or control channel such as control resource set (CORESET), PUCCH, or RS signal such as CSI-RS and SRS. For example, when no TCI codepoint is indicated by any DCI 414, the TCI codepoint with the lowest codepoint ID value (e.g., C₀) or the highest codepoint ID value (e.g., C_{N}) may be defined to indicate the set of default common beams. In a TCI codepoint for the default common beam, the 1^{st} TCI state mapped to the codepoint may be used as the default common beam for the resources associated with the 1^{st} TRP, and the 2^{nd} TCI state mapped to the codepoint may be used as the default common beam for the resources associated with the 2^{nd} TRP.

As indicated herein, in some aspects of wireless communications, it may be beneficial to include an enhancement on multiple beam (multi-beam) operation, such as targeting a certain frequency range, e.g., frequency range 2 (FR2), while also applicable to other frequency ranges, e.g., frequency range 1 (FR1). In order to enhance multi-beam operation, features may be identified and specified to facilitate a more efficient, i.e., lower latency and overhead, DL/UL beam management to support higher intra-cell mobility and inter-cell mobility, e.g., layer 1 (L1)/layer 2 (L2)-centric inter-cell mobility, and/or a larger number of configured TCI states. A common beam for data and control transmission or reception for DL and UL, such as for intra-band carrier aggregation (CA), may be specified in order to provide a unified TCI framework for DL and UL beam indication.

Also, enhancement on signaling mechanisms for the aforementioned features may be provided in order to improve latency and efficiency with more usage of dynamic control signaling, such as opposed to RRC signaling. Moreover, features may be identified and specified to facilitate UL beam selection for UEs equipped with multiple panels, considering UL coverage loss mitigation due to a maximum permissible exposure (MPE), based on an UL beam indication with the unified TCI framework for an UL fast panel selection. In some aspects, a unified TCI framework for DL and UL beam indication may be beneficial. In some instances, signaling a common beam for multiple DL and UL resources may help to save both beam indication and overhead latency. The common beam indication may be signaled via a joint DL/UL TCI state. The activation of the joint DL/UL TCI state using a MAC-CE is described herein.

Additionally, a joint DL/UL TCI state may jointly indicate a common beam or a set of common beams applied to each of multiple DL or UL resources. The joint DL/UL TCI state may include a set of information including a variety of information or parameters. For example, each of the joint DL/UL TCI states may include a TCI state identification (ID). The TCI state ID may be included in a dedicated ID space for a common beam indication, or in a common ID space shared for a common DL/UL beam indication, a DL beam indication, and/or an UL beam indication. Further, the joint DL/UL TCI state may include IDs of one or more source reference signals (RSs) that provide at least one DL quasi co-location (QCL) assumption and/or UL spatial relation information. The one or more source RSs may include a serving cell ID and a BWP ID, which may include where the one or more source RSs are located. If the serving cell ID is absent, the serving cell in which the TCI state is configured may be selected. The one or more source RSs may include a number of RS types, including a synchronization signal block (SSB), CSI-RS, a PRS, a PRACH, dedicated demodulation reference signals (DM-RS) of a PDSCH, a PDCCH, a PUCCH, or a PUSCH.

The one or more source RSs may also provide various QCL assumptions and/or spatial relation information, including characteristics on delay, Doppler, and/or spatial Rx/Tx parameters. For example, the QCL may include a certain QCL type, e.g., a QCL-TypeA, including a Doppler shift, a Doppler spread, an average delay, and a delay spread. The QCL may also include a QCL-TypeB including the Doppler shift and the Doppler spread, as well as a QCL-TypeC including the Doppler shift and the average delay, and a QCL-TypeD including a spatial Rx parameter. The one or more source RSs may have different combinations based on provided QCL or spatial assumptions. For instance, the joint DL/UL TCI state may include an ID of one source RS for QCL-TypeA, QCL-TypeB, and/or QCL-TypeC. For example, three source RSs may include a first RS for QCL-TypeA/TypeB/TypeC, a second RS for QCL-Type D, and a third RS for spatial relation information.

Additionally, each of the joint DL/UL TCI states may include UL power control (PC) parameters indicating the UE to configure the UL transmission power. For example, the UL power control parameters may include a pathloss RS ID, a P0, an Alpha, a close-loop index, and a PC group ID. Also, each of the joint DL/UL TCI states may include UL timing advance (TA) parameters indicating the UE to configure the TA for the UL transmission, e.g., TA group ID and/or TA value. Each of the joint DL/UL TCI states may also include one or more parameters for codebook and/or non-codebook based PUSCH transmission, such as an SRS resource indicator (SRI), a transmit precoding matrix indicator (TPMI), or a combination thereof. Moreover, each of the joint DL/UL TCI states may include UE panel IDs or similar IDs, e.g., an antenna port group ID or a beam group ID. For example, the UE panel ID(s) associated with the common DL/UL beam may include two separate panel IDs for DL and UL or a single panel ID for both DL and UL.

In aspects of wireless communication utilizing a single TRP, a TRP or base station may provide a MAC-CE to a UE to activate one or more configured joint DL/UL TCI states. In some aspects, the DCI and/or MAC-CE may activate subsets of configured joint DL/UL TCI states, where each joint DL/UL TCI state may indicate a common beam for DL reception/UL transmission. Accordingly, a set of joint DL/UL states may be configured, and the base station may transmit a MAC-CE to the UE in order to indicate to the UE to activate one or more subsets of the configured joint DL/UL TCI states. Based on the above, it may be beneficial to activate joint DL/UL TCI states in multiple DCI or multi-DCI (mDCI) based multiple TRP or multi-TRP (mTRP) communication, where each DCI may schedule UL transmissions or DL receptions associated with a TRP.

Aspects of the present disclosure may provide for an activation of joint DL/UL TCI states. In some instances, aspects of the present disclosure may be applicable to mDCI based mTRP communication. For instance, aspects of the present disclosure may activate joint DL/UL TCI states in mDCI based mTRP communication. In aspects utilizing multi-DCI based multi-TRP communication, each TRP may individually schedule DL reception or UL transmission by sending its own DCI. In this case, a TRP ID, e.g., a CORESET pool ID, may be introduced in the MAC-CE activating the joint DL/UL TCI state(s). The joint DL/UL TCI state(s) activated by the MAC-CE may be applied for the DL reception or UL transmission scheduled by a DCI in CORESET(s) with a CORESET pool ID equal to the CORESET pool ID indicated in the MAC-CE. Although the CORESET pool ID is used as an example for TRP ID, the TRP ID may have other similar IDs, such as an antenna port group ID, a panel ID, a beam ID or a beam group ID, etc.

In some aspects of the present disclosure, the DL receptions and the UL transmissions may be associated with a number of different channels. In some instances, the DL receptions may include a physical downlink control channel (PDCCH), a physical downlink shared channel (PDSCH), channel state information (CSI) reference signals (RS) (CSI-RS), or positioning reference signals (PRS). Additionally, the UL transmissions may include a physical uplink control channel (PUCCH), a physical uplink shared channel (PUSCH), sounding reference signals (SRS), or a physical random access channel (PRACH).

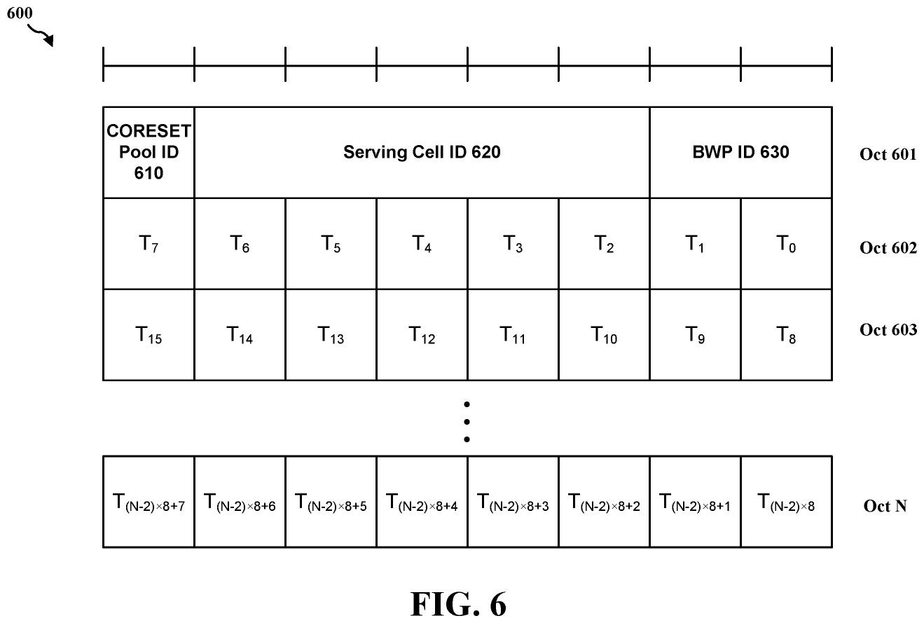

FIG. 6 is a diagram illustrating MAC-CE 600. As shown in FIG. 6, MAC-CE includes CORESET pool ID 610, serving cell ID 620, and BWP ID 630, as well as a number of octets (Oct), e.g., Oct 601, Oct 602, Oct 603, and Oct N. The MAC-CE 600 may include a bitmap indicating which configured joint DL/UL TCI state(s) are activated, a serving cell ID, e.g., serving cell ID 620, and a BWP ID, e.g., BWP ID 630, for which the MAC-CE 600 applies. As depicted in FIG. 6, the MAC-CE 600 may include a variable sized bitmap including a CORESET pool ID, a serving cell ID field, a BWP ID field, and a number of TCI state fields. For example, a first octet (Oct) of the bitmap of MAC-CE 600, e.g., Oct 601, may include the CORESET pool ID 610, the serving cell ID 620, and the BWP ID 630.

In some aspects, the CORESET pool ID, e.g., CORESET pool ID 610, may indicate whether a mapping between the activated TCI states and a codepoint of the DCI is preconfigured or based on a predefined rule. For example, the length of the CORESET pool ID 610 may be a number of bits, e.g., one (1) bit, which may be used to indicate the TCI states for one of two TRPs. The serving cell ID 620 may indicate the identity of the serving cell for which the MAC-CE 600 applies. For example, the length of the serving cell ID 620 may also be a number of bits, e.g., five (5) bits. The BWP ID 630 may indicate a DL BWP for which the MAC-CE 600 applies as the codepoint. For example, the length of the BWP ID field may be a number of bits, e.g., two (2) bits.

Outside of the first octet, the remaining octets may be a bitmap of the joint DL/UL TCI states, where each bit corresponds to each joint DL/UL TCI state. As shown in FIG. 6, the bitmap may include a first TCI state, e.g., T₀, up through a last TCI state, e.g., T_{(N-2)×8+7}. If a bit is set to a certain value, e.g., one (1), then the corresponding joint DL/UL TCI state may be activated. If a bit is set to another value, e.g., zero (0), then the corresponding joint DL/UL TCI state may not be activated. The base station may configure up to a certain number of joint DL/UL TCI states, e.g., 128 joint DL/UL TCI states, and the bitmap may have a bit length of a certain number of bits, e.g., 128 bits. The MAC-CE 600 may select up to a certain amount of bits, e.g., eight (8) bits. As such, the bitmap may have up to this amount of bits, e.g., eight (8) bits, set to a certain value, e.g., one (1), in order to activate a corresponding joint DL/UL TCI state.

Some aspects of the present disclosure may include an applicable DL/UL channel type or resource per activated joint DL/UL TCI state associated with a CORESET pool ID. This applicable DL/UL channel type or resource may be determined based on a number of different options or aspects. In one aspect, the applicable DL/UL channel types or resources may be preconfigured or predefined in a specification. For example, the activated joint DL/UL TCI state may be applied to each DL/UL channel type or resource scheduled by the DCI in CORESET(s) with a same CORESET pool ID as the joint DL/UL TCI state in the component carrier (CC) where the MAC-CE is applied.

In another aspect of the present disclosure, the applicable DL/UL channel types or resources may be configured or indicated by a base station or TRP. For example, the applicable DL/UL channel types or resources may be configured or indicated via RRC signaling, a MAC-CE, or DCI. Additionally, a base station or TRP may indicate that one activated joint DL/UL TCI state may be applied to all or a subset of DL/UL channel types or resources. These DL/UL channel types or resources may be scheduled by a DCI in CORESET(s) with the same CORESET pool ID as the joint DL/UL TCI state in the CC where the MAC-CE is applied.

In some aspects, if multiple joint DL/UL TCI states are activated by the MAC-CE for a CORESET pool ID, a DCI may further indicate a TCI codepoint mapped to one activated joint DL/UL TCI state. The joint DL/UL TCI state(s) activated by the MAC-CE may be sequentially mapped to candidate TCI codepoint(s) associated with the same CORESET pool ID. In some instances, the activated joint DL/UL TCI state(s) may be dynamically indicated by a DCI in a CORESET with a same CORESET pool ID. For example, the MAC-CE may activate certain joint DL/UL TCI state ID(s), e.g., joint DL/UL TCI state IDs 5, 7, and 9 corresponding to T₅, T₇, and T₉ in the MAC-CE, for a certain CORESET pool ID, e.g., a CORESET pool ID of zero (0). These joint DL/UL TCI state IDs may be sequentially mapped to candidate TCI codepoints with certain values, e.g., values of 0, 1, and/or 2, for the DCI in CORESET(s) with a same CORESET pool ID.

Additionally, in some aspects, the indicated TCI codepoint may be used for DL receptions/UL transmissions scheduled by the same DCI. Also, the applicable DL reception/UL transmission may be indicated or predefined in a specification or indicated by a base station or TRP, e.g., via RRC signaling, a MAC-CE, or DCI. For example, a specification may describe that the TCI codepoint indicated by a DCI is applied to all DL receptions or UL transmissions scheduled by CORESET(s) with a CORESET pool ID which is the same as the CORESET pool ID indicated in the MAC-CE for activating the corresponding TCI codepoint. Moreover, the base station or TRP may indicate, e.g., through RRC, MAC-CE signaling or DCI, that the TCI codepoint indicated by the DCI is applied to a subset of DL receptions or UL transmissions scheduled by CORESET(s) with a CORESET pool ID which is the same as the CORESET pool ID indicated in the MAC-CE for activating the corresponding TCI codepoint.

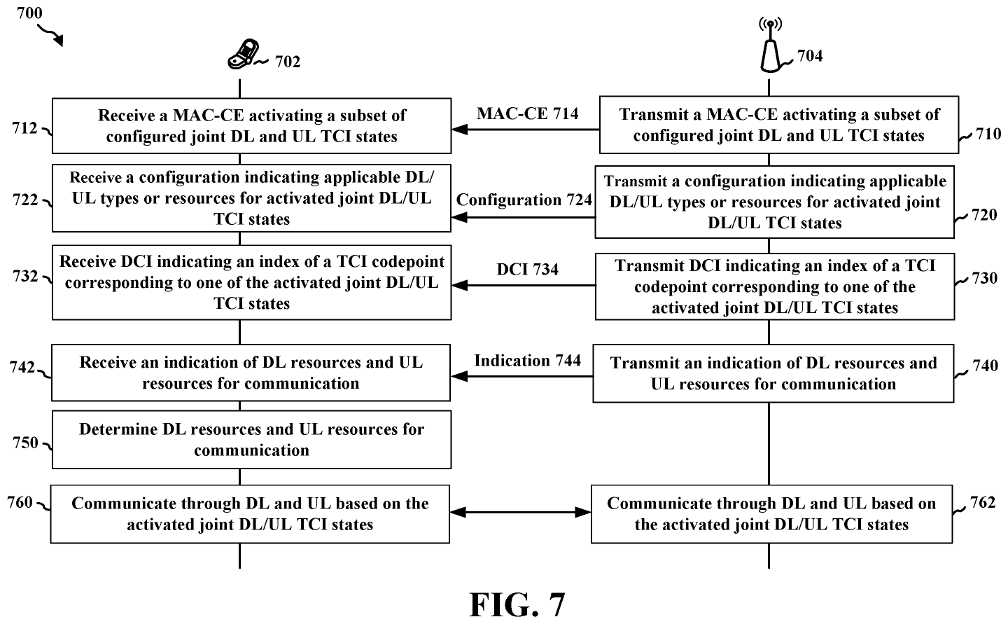

FIG. 7 is a diagram 700 illustrating example communication between a UE 702 and a TRP or base station 704.

At 710, TRP 704 may transmit, to a UE, e.g., UE 702, a MAC-CE activating a subset of configured joint DL and UL TCI states, configured DL TCI states, or configured UL TCI states, e.g., MAC-CE 714, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. At 712, UE 702 may receive, from a TRP, e.g., TRP 704, a MAC-CE activating a subset of configured joint DL and UL TCI states, configured DL TCI states, or configured UL TCI states, e.g., MAC-CE 714, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs.

In some aspects, the MAC-CE may include a bitmap indicating the CORESET pool ID and which of the configured joint DL and UL TCI states, the configured DL TCI states, or the configured UL TCI states are activated in association with the CORESET pool ID. Also, each of the activated joint DL and UL TCI states, the activated DL TCI states, or the activated UL TCI states may be associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL. Further, each of the activated joint DL and UL TCI states, the activated DL TCI states, or the activated UL TCI states may be associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID.

At 720, TRP 704 may transmit a configuration, e.g., configuration 724, indicating which of the at least one of the PDCCH, the PDSCH, the CSI-RS, or the PRS for DL that is scheduled by a CORESET associated with the CORESET pool ID is applicable to each of the activated joint DL and UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states. At 722, UE 702 may receive a configuration, e.g., configuration 724, indicating which of the at least one of the PDCCH, the PDSCH, the CSI-RS, or the PRS for DL that is scheduled by a CORESET associated with the CORESET pool ID is applicable to each of the activated joint DL and UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states. In some aspects, the configuration may be received through at least one of radio resource control (RRC) signaling, a MAC-CE, or downlink control information (DCI).

At 730, TRP 704 may transmit DCI, e.g., DCI 734, in a CORESET associated with the CORESET pool ID, the DCI indicating an index of a TCI codepoint, the index corresponding to one of the activated joint DL and UL TCI states associated with the CORESET pool ID. At 732, UE 702 may receive DCI, e.g., DCI 734, in a CORESET associated with the CORESET pool ID, the DCI indicating an index of a TCI codepoint, the index corresponding to one of the activated joint DL and UL TCI states associated with the CORESET pool ID.

In some instances, the joint DL and UL TCI states, the DL TCI states, or the UL TCI states activated in the MAC-CE are mapped with sequential indexes to the TCI codepoint, the TCI codepoint being associated with the CORESET pool ID. Also, the received DCI may schedule the communication through DL or UL, and the communication through DL or UL scheduled through the DCI may be based on the one of the activated joint DL and UL TCI states, the activated DL TCI states, or the activated UL TCI states corresponding to the index of the TCI codepoint indicated through the DCI.

At 740, TRP 704 may transmit an indication, e.g., indication 744, of DL resources and UL resources for communication scheduled by one or more CORESETs associated with the CORESET pool ID, where the DL resources and the UL resources for the communication scheduled by the one or more CORESETs associated with the CORESET pool ID are based on the transmitted indication. At 742, UE 702 may receive an indication, e.g., indication 744, of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication. Also, the indication may be received through one of radio resource control (RRC) signaling, a MAC-CE, or downlink control information (DCI).

At 750, UE 702 may determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID. In some instances, the DL resources and UL resources for the communication may be preconfigured or predetermined.

At 760, UE 702 may communicate with the TRP, e.g., TRP 704, through DL and UL scheduled through one or more CORESETs of the set of CORESETs associated with the CORESET pool ID based on the activated joint DL and UL TCI states, the activated DL TCI states, or the activated UL TCI states. At 762, TRP 704 may communicate with the UE, e.g., UE 702, through DL and UL scheduled through one or more CORESETs of the set of CORESETs associated with the CORESET pool ID based on the activated joint DL and UL TCI states, the activated DL TCI states, or the activated UL TCI states.

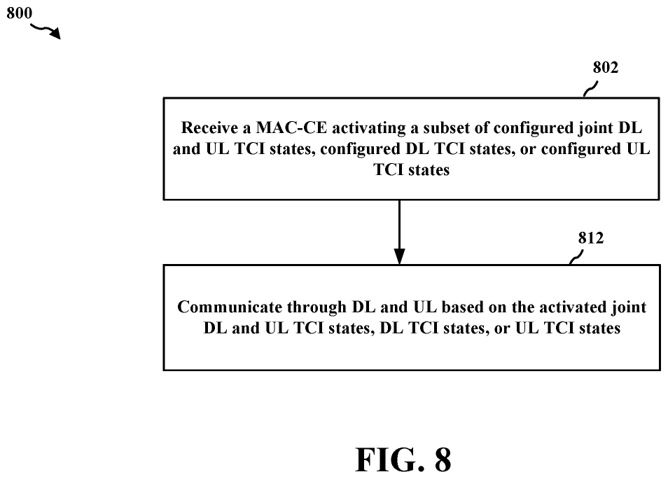

FIG. 8 is a flowchart 800 of a method of wireless communication. The method may be performed by a UE or a component of a UE (e.g., the UE 104, 350, 702; the apparatus 1202; a processing system, which may include the memory 360 and which may be the entire UE or a component of the UE, such as the TX processor 368, the controller/processor 359, transmitter 354TX, antenna(s) 352, and/or the like). The methods described herein may provide a number of benefits, such as improving communication signaling, resource utilization, and/or power savings.

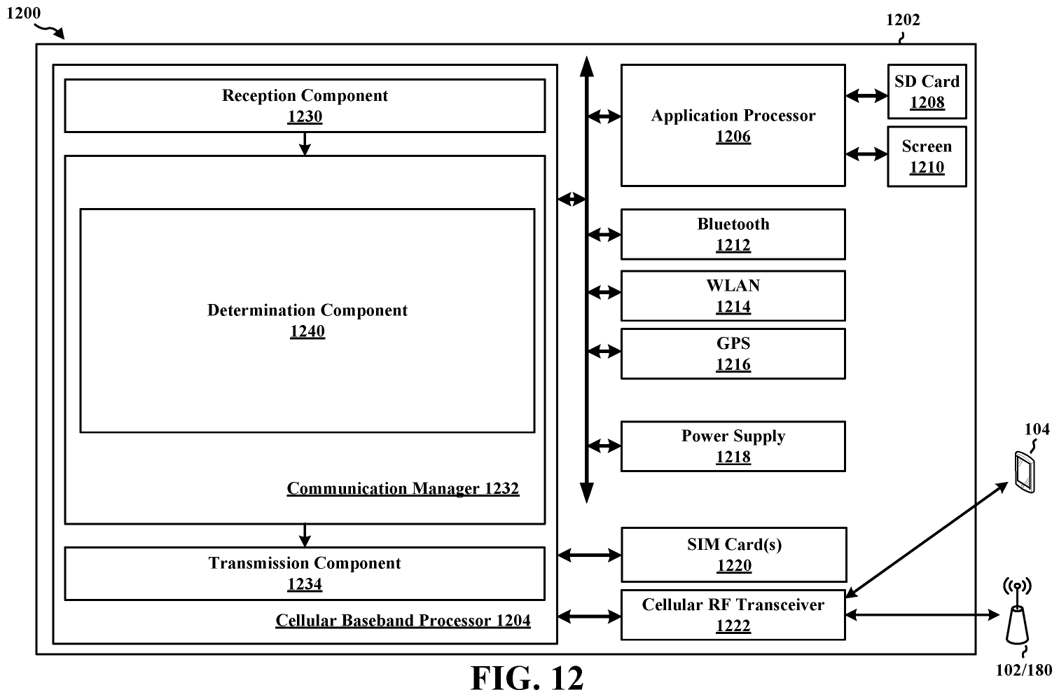

At 802, the UE may receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs, as described in connection with the examples in FIGS. 4-7. For example, UE 702 may receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. Further, 802 may be performed by determination component 1240 in FIG. 12.

In some aspects, the MAC-CE may include a bitmap indicating the CORESET pool ID and which of the configured joint DL and UL TCI states, the configured DL TCI states, or the configured UL TCI states are activated in association with the CORESET pool ID, as described in connection with the examples in FIGS. 4-7. Also, each of the activated joint DL and UL TCI states, the activated DL TCI states, or the activated UL TCI states may be associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL, as described in connection with the examples in FIGS. 4-7. Further, each of the activated joint DL and UL TCI states, the activated DL TCI states, or the activated UL TCI states may be associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID, as described in connection with the examples in FIGS. 4-7.

At 812, the UE may communicate with the TRP through DL and UL scheduled through one or more CORESETs of the set of CORESETs associated with the CORESET pool ID based on the activated joint DL and UL TCI states, the activated DL TCI states, or the activated UL TCI states, as described in connection with the examples in FIGS. 4-7. For example, UE 702 may communicate with the TRP through DL and UL scheduled through one or more CORESETs of the set of CORESETs associated with the CORESET pool ID based on the activated joint DL and UL TCI states, the activated DL TCI states, or the activated UL TCI states. Further, 812 may be performed by determination component 1240 in FIG. 12.

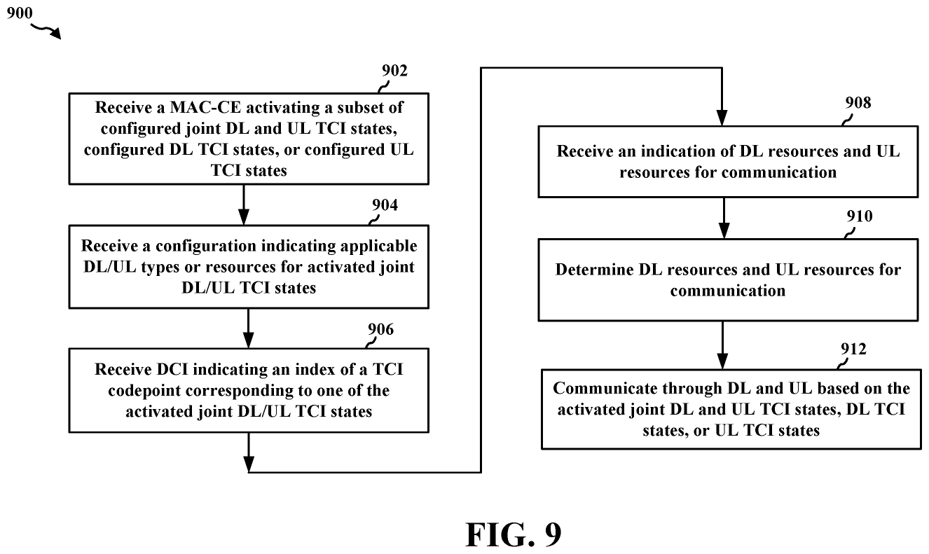

FIG. 9 is a flowchart 900 of a method of wireless communication. The method may be performed by a UE or a component of a UE (e.g., the UE 104, 350, 702; the apparatus 1202; a processing system, which may include the memory 360 and which may be the entire UE or a component of the UE, such as the TX processor 368, the controller/processor 359, transmitter 354TX, antenna(s) 352, and/or the like). The methods described herein may provide a number of benefits, such as improving communication signaling, resource utilization, and/or power savings.

At 902, the UE may receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs, as described in connection with the examples in FIGS. 4-7. For example, UE 702 may receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. Further, 902 may be performed by determination component 1240 in FIG. 12.

In some aspects, the MAC-CE may include a bitmap indicating the CORESET pool ID and which of the configured joint DL and UL TCI states, the configured DL TCI states, or the configured UL TCI states are activated in association with the CORESET pool ID, as described in connection with the examples in FIGS. 4-7. Also, each of the activated joint DL and UL TCI states, the activated DL TCI states, or the activated UL TCI states may be associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL, as described in connection with the examples in FIGS. 4-7. Further, each of the activated joint DL and UL TCI states, the activated DL TCI states, or the activated UL TCI states may be associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID, as described in connection with the examples in FIGS. 4-7.

At 904, the UE may receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states, as described in connection with the examples in FIGS. 4-7. For example, UE 702 may receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states. Further, 904 may be performed by determination component 1240 in FIG. 12. In some aspects, the configuration may be received through at least one of radio resource control (RRC) signaling, a MAC-CE, or downlink control information (DCI), as described in connection with the examples in FIGS. 4-7.

At 906, the UE may receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID, as described in connection with the examples in FIGS. 4-7. For example, UE 702 may receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID. Further, 906 may be performed by determination component 1240 in FIG. 12.

In some instances, the joint DL and UL TCI states, the DL TCI states, or the UL TCI states activated in the MAC-CE are mapped with sequential indexes to the TCI codepoint, the TCI codepoint being associated with the CORESET pool ID, as described in connection with the examples in FIGS. 4-7. Also, the received DCI may schedule the communication through DL or UL, and the communication through DL or UL scheduled through the DCI is based on the one of the activated joint DL and UL TCI states, the activated DL TCI states, or the activated UL TCI states corresponding to the index of the TCI codepoint indicated through the DCI, as described in connection with the examples in FIGS. 4-7.

At 908, the UE may receive an indication of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication, as described in connection with the examples in FIGS. 4-7. For example, UE 702 may receive an indication of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication. Further, 908 may be performed by determination component 1240 in FIG. 12. Also, the indication may be received through one of radio resource control (RRC) signaling, a MAC-CE, or downlink control information (DCI), as described in connection with the examples in FIGS. 4-7.

At 910, the UE may determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID, as described in connection with the examples in FIGS. 4-7. For example, UE 702 may determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID. Further, 910 may be performed by determination component 1240 in FIG. 12. In some instances, the DL resources and UL resources for the communication may be preconfigured or predetermined, as described in connection with the examples in FIGS. 4-7.

At 912, the UE may communicate with the TRP through DL and UL scheduled through one or more CORESETs of the set of CORESETs associated with the CORESET pool ID based on the activated joint DL and UL TCI states, the activated DL TCI states, or the activated UL TCI states, as described in connection with the examples in FIGS. 4-7. For example, UE 702 may communicate with the TRP through DL and UL scheduled through one or more CORESETs of the set of CORESETs associated with the CORESET pool ID based on the activated joint DL and UL TCI states, the activated DL TCI states, or the activated UL TCI states. Further, 912 may be performed by determination component 1240 in FIG. 12.

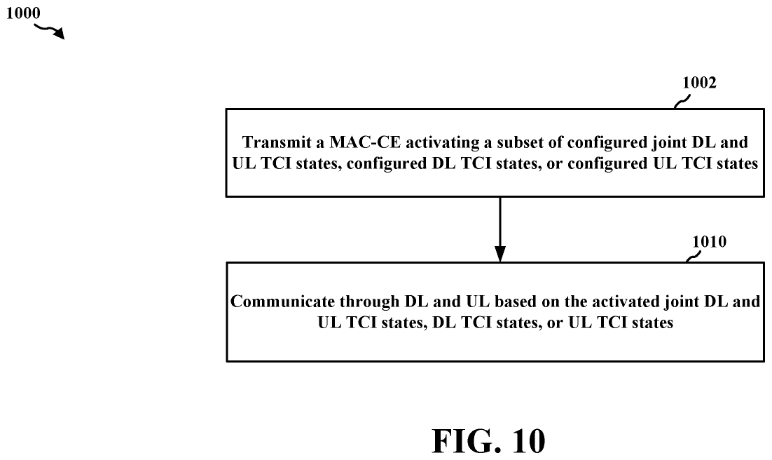

FIG. 10 is a flowchart 1000 of a method of wireless communication. The method may be performed by a TRP or a base station or a component of a TRP or a base station (e.g., the base station 102, 180, 310, 704; the apparatus 1302; a processing system, which may include the memory 376 and which may be the entire base station or a component of the base station, such as the antenna(s) 320, receiver 318RX, the RX processor 370, the controller/processor 375, and/or the like). The methods described herein may provide a number of benefits, such as improving communication signaling, resource utilization, and/or power savings.

At 1002, the TRP may transmit, to a user equipment (UE), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs, as described in connection with the examples in FIGS. 4-7. For example, TRP 704 may transmit, to a user equipment (UE), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. Further, 1002 may be performed by determination component 1340.

In some aspects, the MAC-CE may include a bitmap indicating the CORESET pool ID and which of the configured joint DL and UL TCI states, the configured DL TCI states, or the configured UL TCI states are activated in association with the CORESET pool ID, as described in connection with the examples in FIGS. 4-7. Also, each of the activated joint DL and UL TCI states, the activated DL TCI states, or the activated UL TCI states may be associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL, as described in connection with the examples in FIGS. 4-7. Further, each of the activated joint DL and UL TCI states, the activated DL TCI states, or the activated UL TCI states may be associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID, as described in connection with the examples in FIGS. 4-7.

At 1010, the TRP may communicate with the UE through DL and UL scheduled through one or more CORESETs of the set of CORESETs associated with the CORESET pool ID based on the activated joint DL and UL TCI states, the activated DL TCI states, or the activated UL TCI states, as described in connection with the examples in FIGS. 4-7. For example, TRP 704 may communicate with the UE through DL and UL scheduled through one or more CORESETs of the set of CORESETs associated with the CORESET pool ID based on the activated joint DL and UL TCI states, the activated DL TCI states, or the activated UL TCI states. Further, 1010 may be performed by determination component 1340.

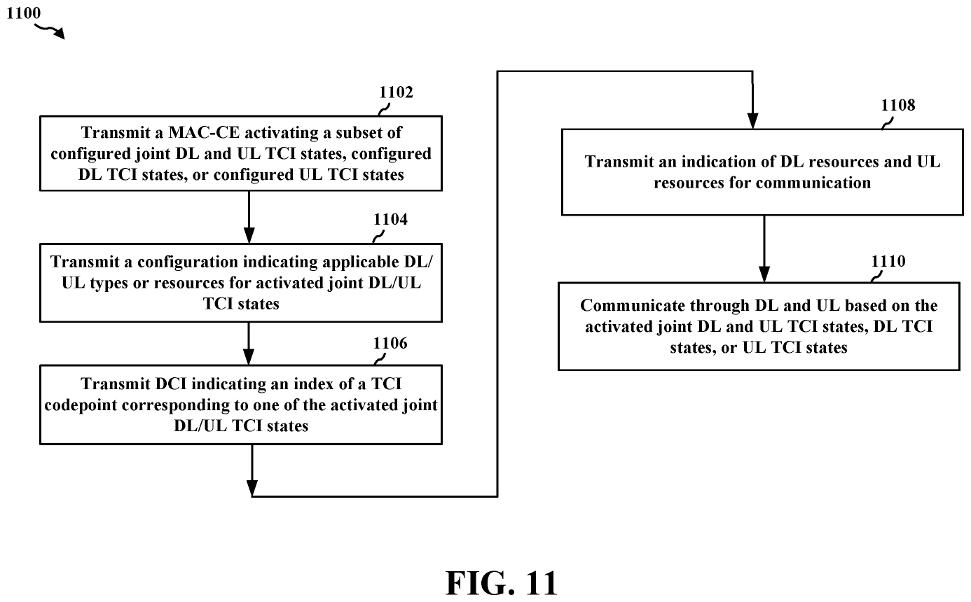

FIG. 11 is a flowchart 1100 of a method of wireless communication. The method may be performed by a TRP or a base station or a component of a TRP or a base station (e.g., the base station 102, 180, 310, 704; the apparatus 1302; a processing system, which may include the memory 376 and which may be the entire base station or a component of the base station, such as the antenna(s) 320, receiver 318RX, the RX processor 370, the controller/processor 375, and/or the like). The methods described herein may provide a number of benefits, such as improving communication signaling, resource utilization, and/or power savings.

At 1102, the TRP may transmit, to a user equipment (UE), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs, as described in connection with the examples in FIGS. 4-7. For example, TRP 704 may transmit, to a user equipment (UE), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs. Further, 1102 may be performed by determination component 1340.

In some aspects, the MAC-CE may include a bitmap indicating the CORESET pool ID and which of the configured joint DL and UL TCI states, the configured DL TCI states, or the configured UL TCI states are activated in association with the CORESET pool ID, as described in connection with the examples in FIGS. 4-7. Also, each of the activated joint DL and UL TCI states, the activated DL TCI states, or the activated UL TCI states may be associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL, as described in connection with the examples in FIGS. 4-7. Further, each of the activated joint DL and UL TCI states, the activated DL TCI states, or the activated UL TCI states may be associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID, as described in connection with the examples in FIGS. 4-7.

At 1104, the TRP may transmit a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states, as described in connection with the examples in FIGS. 4-7. For example, TRP 704 may transmit a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states. Further, 1104 may be performed by determination component 1340. In some aspects, the configuration may be transmitted through at least one of radio resource control (RRC) signaling, a MAC-CE, or downlink control information (DCI), as described in connection with the examples in FIGS. 4-7.

At 1106, the TRP may transmit downlink control information (DCI) in a CORESET associated with the CORESET pool ID, the DCI indicating an index of a TCI codepoint, the index corresponding to one of the activated joint DL and UL TCI states associated with the CORESET pool ID, as described in connection with the examples in FIGS. 4-7. For example, TRP 704 may transmit downlink control information (DCI) in a CORESET associated with the CORESET pool ID, the DCI indicating an index of a TCI codepoint, the index corresponding to one of the activated joint DL and UL TCI states associated with the CORESET pool ID. Further, 1106 may be performed by determination component 1340.

In some instances, the joint DL and UL TCI states, the DL TCI states, or the UL TCI states activated in the MAC-CE are mapped with sequential indexes to the TCI codepoint, the TCI codepoint being associated with the CORESET pool ID, as described in connection with the examples in FIGS. 4-7. Also, the transmitted DCI may schedule the communication through DL or UL, and the communication through DL or UL scheduled through the DCI may be based on the one activated joint DL and UL TCI state corresponding to the index of the TCI codepoint indicated through the DCI, as described in connection with the examples in FIGS. 4-7. Additionally, DL resources and UL resources for the communication to which the one activated joint DL and UL TCI state corresponding to the index of the TCI codepoint indicated through the DCI applies may be scheduled by the one or more CORESETs associated with the CORESET pool ID, as described in connection with the examples in FIGS. 4-7. Further, the DL resources and UL resources for the communication may be preconfigured or predetermined, as described in connection with the examples in FIGS. 4-7.

At 1108, the TRP may transmit an indication of DL resources and UL resources for communication scheduled by one or more CORESETs associated with the CORESET pool ID, where the DL resources and the UL resources for the communication scheduled by the one or more CORESETs associated with the CORESET pool ID are based on the transmitted indication, as described in connection with the examples in FIGS. 4-7. For example, TRP 704 may transmit an indication of DL resources and UL resources for communication scheduled by one or more CORESETs associated with the CORESET pool ID, where the DL resources and the UL resources for the communication scheduled by the one or more CORESETs associated with the CORESET pool ID are based on the transmitted indication. Further, 1108 may be performed by determination component 1340. The indication may be transmitted through one of radio resource control (RRC) signaling, a MAC-CE, or downlink control information (DCI), as described in connection with the examples in FIGS. 4-7.

At 1110, the TRP may communicate with the UE through DL and UL scheduled through one or more CORESETs of the set of CORESETs associated with the CORESET pool ID based on the activated joint DL and UL TCI states, the activated DL TCI states, or the activated UL TCI states, as described in connection with the examples in FIGS. 4-7. For example, TRP 704 may communicate with the UE through DL and UL scheduled through one or more CORESETs of the set of CORESETs associated with the CORESET pool ID based on the activated joint DL and UL TCI states, the activated DL TCI states, or the activated UL TCI states. Further, 1110 may be performed by determination component 1340.

FIG. 12 is a diagram 1200 illustrating an example of a hardware implementation for an apparatus 1202. The apparatus 1202 is a UE and includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the aforediscussed additional modules of the apparatus 1202.

The communication manager 1232 includes a determination component 1240 that is configured to receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs, e.g., as described in connection with step 902 above. Determination component 1240 may also be configured to receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states and indicating which of the at least one of the PUCCH, the PUSCH, the SRS, or the PRACH for UL that is scheduled by a CORESET associated with the CORESET pool ID is applicable to each of the activated joint DL and UL TCI states, e.g., as described in connection with step 904 above. Determination component 1240 may also be configured to receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID, e.g., as described in connection with step 906 above. Determination component 1240 may also be configured to receive an indication of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication, e.g., as described in connection with step 908 above. Determination component 1240 may also be configured to determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID, e.g., as described in connection with step 910 above. Determination component 1240 may also be configured to communicate with the TRP through DL and UL scheduled through one or more CORESETs of the set of CORESETs associated with the CORESET pool ID based on the activated joint DL and UL TCI states, the activated DL TCI states, or the activated UL TCI states, e.g., as described in connection with step 912 above.

The apparatus may include additional components that perform each of the blocks of the algorithm in the aforementioned flowcharts of FIGS. 7-9. As such, each block in the aforementioned flowcharts of FIGS. 7-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for receiving, from a transmission reception point (TRP), a media access control (MAC) control element (CE) (MAC-CE) activating a subset of configured joint downlink (DL) and uplink (UL) transmission configuration indicator (TCI) states, each activated joint DL and UL TCI state indicating a common beam for communication in DL and UL, the MAC-CE indicating a control resource set (CORESET) pool identifier (ID) associated with a set of CORESETs; means for receiving a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states and indicating which of the at least one of the PUCCH, the PUSCH, the SRS, or the PRACH for UL that is scheduled by a CORESET associated with the CORESET pool ID is applicable to each of the activated joint DL and UL TCI states; means for receiving downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID; means for receiving an indication of DL resources and UL resources for communication scheduled by one or more CORESETs associated with the CORESET pool ID, where the DL resources and the UL resources for the communication scheduled by the one or more CORESETs associated with the CORESET pool ID are determined based on the received indication; means for determining DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID; and means for communicating with the TRP through DL and UL scheduled through one or more CORESETs of the set of CORESETs associated with the CORESET pool ID based on the activated joint DL and UL TCI states. The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

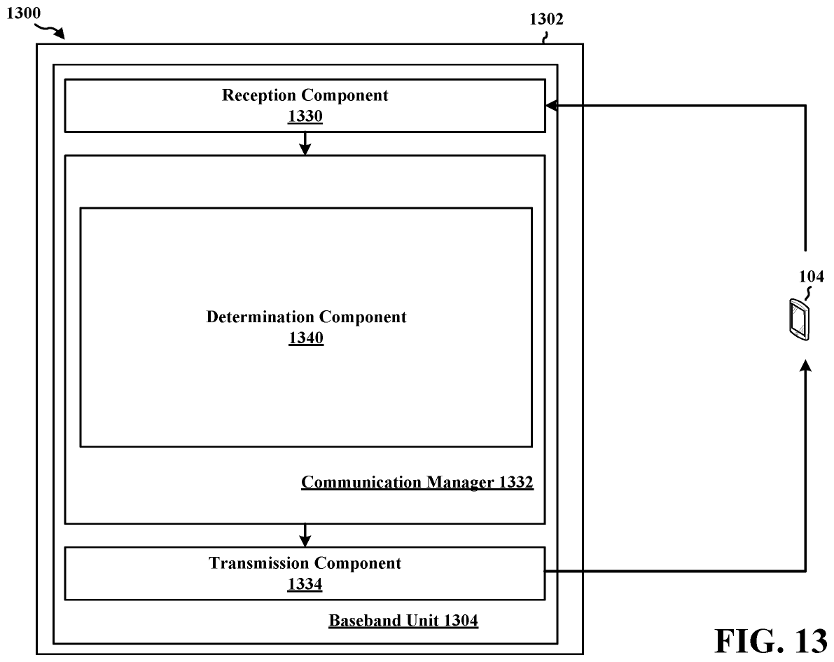

FIG. 13 is a diagram 1300 illustrating an example of a hardware implementation for an apparatus 1302. The apparatus 1302 is a base station and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 310 and may include the memory 376 and/or at least one of the TX processor 316, the RX processor 370, and the controller/processor 375.

The communication manager 1332 includes a determination component 1340 that is configured to transmit, to a UE, a media access control (MAC) control element (CE) (MAC-CE) activating a subset of configured joint downlink (DL) and uplink (UL) transmission configuration indicator (TCI) states, each activated joint DL and UL TCI state indicating a common beam for communication in DL and UL, the MAC-CE indicating a control resource set (CORESET) pool identifier (ID) associated with a set of CORESETs, e.g., as described in connection with step 702 above. Determination component 1340 may also be configured to communicate with the UE through DL and UL scheduled through one or more CORESETs of the set of CORESETs associated with the CORESET pool ID based on the activated joint DL and UL TCI states, e.g., as described in connection with step 710 above.

The apparatus may include additional components that perform each of the blocks of the algorithm in the aforementioned flowcharts of FIGS. 7, 10, and 11. As such, each block in the aforementioned flowcharts of FIGS. 7, 10, and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for transmitting, to a UE, a media access control (MAC) control element (CE) (MAC-CE) activating a subset of configured joint downlink (DL) and uplink (UL) transmission configuration indicator (TCI) states, each activated joint DL and UL TCI state indicating a common beam for communication in DL and UL, the MAC-CE indicating a control resource set (CORESET) pool identifier (ID) associated with a set of CORESETs. The apparatus 1302 may also include means for communicating with the UE through DL and UL scheduled through one or more CORESETs of the set of CORESETs associated with the CORESET pool ID based on the activated joint DL and UL TCI states. The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

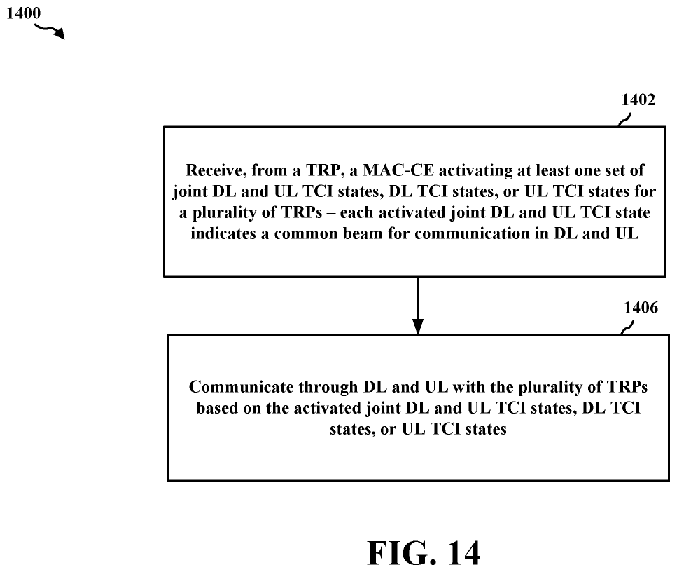

FIG. 14 is a flowchart 1400 of a method of wireless communication. The method may be performed by a UE (e.g., the UE 104, 702; the apparatus 1702). At 1402, the UE receives, from a transmission reception point (TRP), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. For example, referring to FIGS. 4, 5, the UE 402 receives, from a TRP, a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. In one example, the MAC-CE 412 may activate a 0^{th} set of joint DL/UL TCI states through fields C₀, R (where R may be optional). Each activated joint DL/UL TCI state corresponding to TCI state ID_{0,1} and TCI state ID_{0,2} indicates a common beam for communication in DL/UL. Further, 1402 may be performed by joint DL/UL TCI state activation component 1740.

In addition, at 1406, the UE communicates through DL and UL with the plurality of TRPs based on the activated joint DL and UL TCI states, the activated DL TCI states, or the activated UL TCI states. For example, referring to FIGS. 4, 5, the UE 402 communicates through DL and UL with the plurality of TRPs based on the activated joint DL and UL TCI states, the activated DL TCI states, or the activated UL TCI states. In one example, the UE 402 may communicate 416 through DL/UL with the TRP 406 based on the joint DL/UL TCI state corresponding to TCI state ID_{0,1}, and the UE 402 may communicate 416 through DL/UL with the TRP 408 based on the joint DL/UL TCI state corresponding to TCI state ID_{0,2}. The communication 416 through DL/UL based on the joint DL/UL TCI state corresponds to using a common beam (receive beam/transmit beam) for receiving from and transmitting to the TRP. Further, 1406 may be performed by joint DL/UL TCI state activation component 1740.

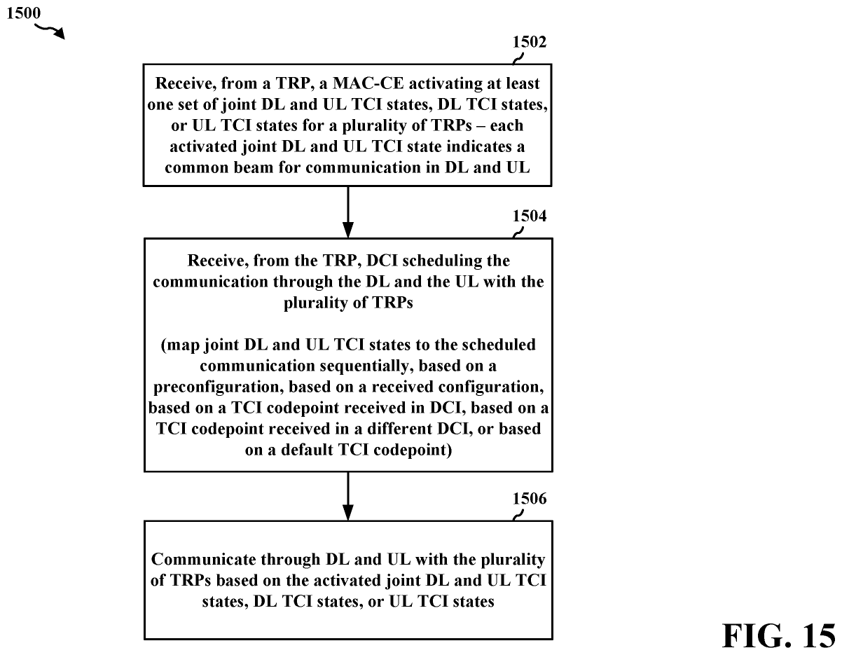

FIG. 15 is a flowchart 1500 of a method of wireless communication. The method may be performed by a UE (e.g., the UE 104, 702; the apparatus 1702). At 1502, the UE receives, from a transmission reception point (TRP), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. For example, referring to FIGS. 4, 5, the UE 402 receives, from a TRP, a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. In one example, the MAC-CE 412 may activate a 0^{th} set of joint DL/UL TCI states through fields C₀, R (where R may be optional). Each activated joint DL/UL TCI state corresponding to TCI state ID_{0,1} and TCI state ID_{0,2} indicates a common beam for communication in DL/UL. Further, 1502 may be performed by joint DL/UL TCI state activation component 1740.

In addition, at 1506, the UE communicates through DL and UL with the plurality of TRPs based on the activated joint DL and UL TCI states, the activated DL TCI states, or the activated UL TCI states. For example, referring to FIGS. 4, 5, the UE 402 communicates through DL and UL with the plurality of TRPs based on the activated joint DL and UL TCI states, the activated DL TCI states, or the activated UL TCI states. In one example, the UE 402 may communicate 416 through DL/UL with the TRP 406 based on the joint DL/UL TCI state corresponding to TCI state ID_{0,1}, and the UE 402 may communicate 416 through DL/UL with the TRP 408 based on the joint DL/UL TCI state corresponding to TCI state ID_{0,2}. The communication 416 through DL/UL based on the joint DL/UL TCI state corresponds to using a common beam (receive beam/transmit beam) for receiving from and transmitting to the TRP. Further, 1506 may be performed by joint DL/UL TCI state activation component 1740.

In one configuration, at 1504, the UE receives, from the TRP, DCI scheduling the communication through the DL and the UL with the plurality of TRPs. For example, referring to FIGS. 4, 5, the UE 402 receives, from the TRP 406, DCI 414 scheduling the communication 416 through the DL/UL with the plurality of TRPs 406, 408, 410. Further, 1504 may be performed by joint DL/UL TCI state activation component 1740.

In one configuration, as illustrated in FIG. 5, the scheduled communication through the DL and the UL with the plurality of TRPs is associated with at least one of a PDCCH, a PDSCH, CSI-RS, or PRS for DL, and at least one of a PUCCH, a PUSCH, SRS, or a PRACH for UL. In one configuration, the scheduled communication through the DL and the UL with the plurality of TRPs is through at least one of FDM 506, TDM 508, or SDM 510. In one configuration, the at least one set of activated joint DL and UL TCI states includes one set of activated joint DL and UL TCI states, and the activated one set of joint DL and UL TCI states are applied sequentially to the scheduled communication through the DL and the UL with the plurality of TRPs. For example, of the 0^{th} set of joint DL/UL TCI states is activated with C₀ and the optional R joint DL/UL TCI state, the joint DL/UL TCI states corresponding to the TCI state IDs TCI state ID_{0,1}, TCI state ID_{0,2} may be mapped sequentially to the scheduled DL/UL communication with the TRPs 406, 408, respectively.

In one configuration, the activated at least one set of joint DL and UL TCI states are applied to the scheduled communication through the DL and the UL with the plurality of TRPs based on a preconfiguration. That is, the UE 402 may be preconfigured to apply the activated sets of joint DL/UL TCI states C₀, C₁, . . . , C_{N} to scheduled UL/DL communication with a plurality of TRPs. In one configuration, the UE 402 may receive, from a base station 404 associated with the TRP 406 and the plurality of TRPs, a configuration indicating the mapping between the activated at least one set of joint DL and UL TCI states and the scheduled communication through the DL and the UL with the plurality of TRPs. The configuration may be received through one of RRC signaling, a MAC-CE, or DCI.

In one configuration, the MAC-CE includes a bitmap (see FIG. 5) indicating at least one TCI codepoint. For example, the bitmap may indicate a first codepoint mapped to codepoint value 0 through C₀, a second codepoint mapped to codepoint value 1 through C₁, . . . , and an (N+1)^{th} codepoint mapped to codepoint value N through C_{N}. Each TCI codepoint of the at least one TCI codepoint includes a set of TCI state IDs corresponding to at least one of the activated joint DL and UL TCI states, the activated DL TCI states, or the activated UL TCI states. In one configuration, one TCI codepoint of the at least one TCI codepoint is associated with a set of default joint common DL and UL beams. For example, the first codepoint mapped to codepoint value 0 may specify the TCI state IDs associated with the set of default joint common DL/UL beams, and the remaining codepoints mapped to codepoint values 1 to N may specify TCI state IDs associated with non-default joint common DL/UL beams. For another example, the last codepoint mapped to codepoint value N may specify the TCI state IDs associated with the set of default joint common DL/UL beams, and the remaining codepoints mapped to codepoint values 0 to N−1 may specify TCI state IDs associated with non-default joint common DL/UL beams.

In one configuration, the activated at least one set of the joint DL and UL TCI states, the activated DL TCI states, or the activated UL TCI states includes a plurality of sets of activated joint DL and UL TCI states, activated DL TCI states, or activated UL TCI states. Each set corresponds to one TCI codepoint.

In one configuration, the UE receives, from the TRP, DCI scheduling the communication through the DL and the UL with the plurality of TRPs, and indicating a TCI codepoint for the scheduled communication. For example, referring to FIGS. 4, 5, the UE 402 receives, from the TRP 406, DCI 414 scheduling the communication 416 through the DL/UL with the plurality of TRPs, and indicating a TCI codepoint (one of codepoint values 0 to N) for the scheduled DL/UL communication. In such a configuration, the scheduled communication through DL and UL with the plurality of TRPs is based on the indicated TCI codepoint.

In one configuration, the UE receives, from the TRP, DCI indicating a TCI codepoint for DCI scheduled communication. In addition, the UE receives at least one DCI scheduling the communication through the DL and the UL with the plurality of TRPs. The DCI indicating the TCI codepoint and the at least one scheduling DCI are different DCIs. The communication through the DL and the UL with the plurality of TRPs scheduled through the at least one DCI is based on the received TCI codepoint. For example, referring to FIGS. 4, 5, the UE 402 may receive, from the TRP 406, DCI 414 indicating a TCI codepoint (one of codepoint values 0 to N) for DCI scheduled DL/UL communication. In addition, the UE 402 may receive at least one subsequent DCI 414 scheduling the DL/UL communication 416 through the DL/UL with the plurality of TRPs 406, 408. The communication 416 through the DL/UL with the plurality of TRPs 406, 408 scheduled through the at least one DCI is based on the received TCI codepoint providing joint UL/DL TCI states indicating a common beam 502, 504 for communicating with the TRPs 406, 408, respectively.

In one configuration, the UE receives, from the TRP, DCI scheduling the communication through the DL and the UL with the plurality of TRPs. The DCI excludes TCI codepoint information. In such a configuration, the scheduled communication through DL and UL with the plurality of TRPs is based on a default TCI codepoint indicated in the MAC-CE. The default TCI codepoint is associated with a set of default joint common DL and UL beams.

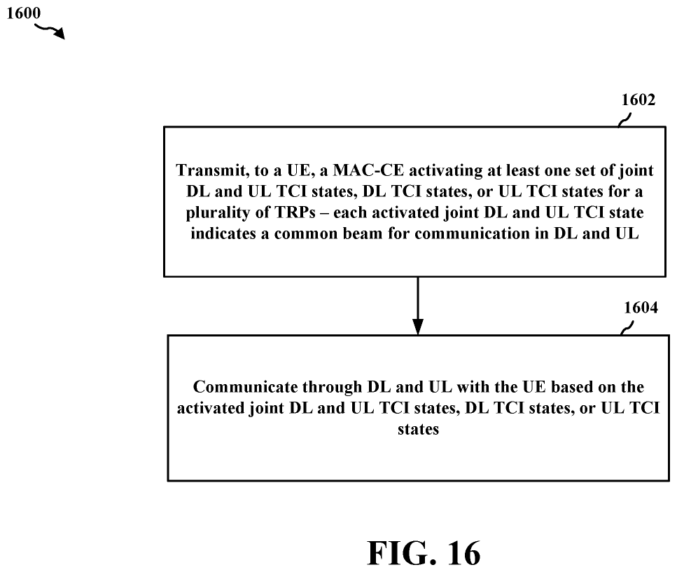

FIG. 16 is a flowchart 1600 of a method of wireless communication. The method may be performed by a TRP or a base station or a component of a TRP or a base station (e.g., the base station 102, 180, 310, 704; the apparatus 1802; a processing system, which may include the memory 376 and which may be the entire base station or a component of the base station, such as the antenna(s) 320, receiver 318RX, the RX processor 370, the controller/processor 375, and/or the like). The methods described herein may provide a number of benefits, such as improving communication signaling, resource utilization, and/or power savings.

At 1602, the TRP may transmit, to a user equipment (UE), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL, as described in connection with the examples in FIGS. 4-7. For example, TRP 704 may transmit, to a user equipment (UE), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. Further, 1602 may be performed by determination component 1840.

At 1604, the TRP may communicate through DL and UL with the UE based on the activated joint DL and UL TCI states, the activated DL TCI states, or the activated UL TCI states, as described in connection with the examples in FIGS. 4-7. For example, TRP 704 may communicate through DL and UL with the UE based on the activated joint DL and UL TCI states, the activated DL TCI states, or the activated UL TCI states. Further, 1604 may be performed by determination component 1840.

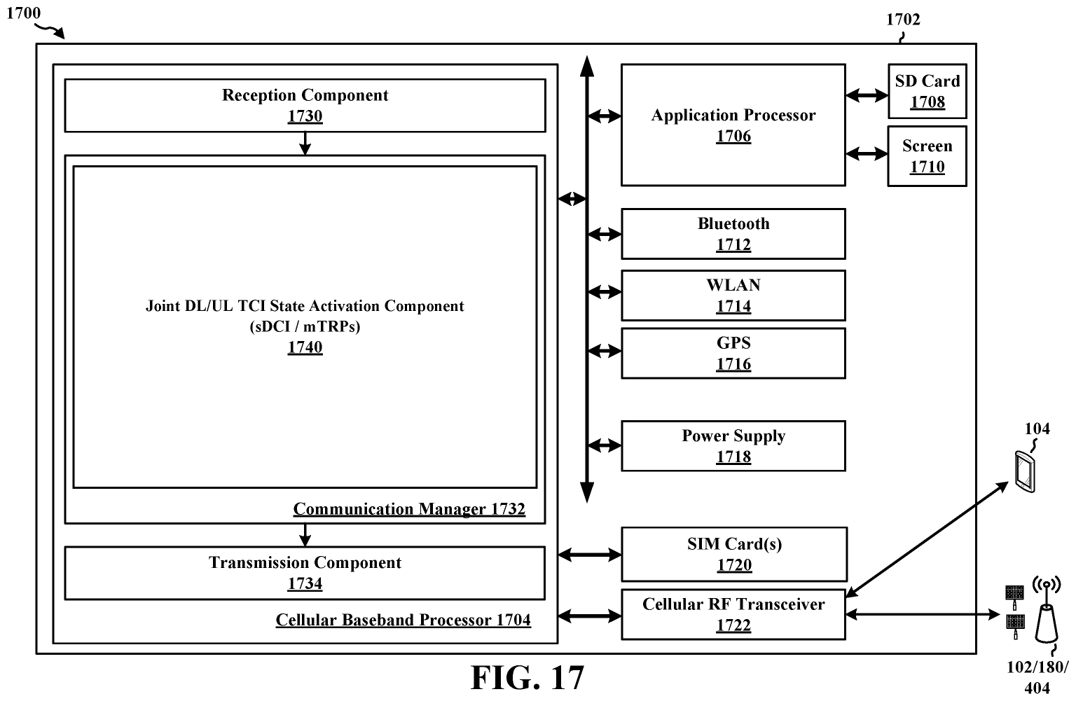

FIG. 17 is a diagram 1700 illustrating an example of a hardware implementation for an apparatus 1702. The apparatus 1702 is a UE and includes a cellular baseband processor 1704 (also referred to as a modem) coupled to a cellular RF transceiver 1722 and one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, and a power supply 1718. The cellular baseband processor 1704 communicates through the cellular RF transceiver 1722 with the UE 104 and/or BS 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704. The cellular baseband processor 1704 may be a component of the UE 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire UE (e.g., see 350 of FIG. 3) and include the aforediscussed additional modules of the apparatus 1702.

The cellular baseband processor 1704 includes a reception component 1730 that is configured to receive, from a transmission reception point (TRP), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. The communication manager 1732 includes a joint DL/UL TCI state activation component 1740 that is configuration to process the received MAC-CE and map joint DL/UL TCI states to scheduled DL/UL communication. The communication manager 1732 coordinates, based on the mapped joint DL/UL TCI states, with the reception component 1730 to select a receive beam for receiving scheduled communication on DL and with the transmission component 1734 to select a transmit beam for transmitting scheduled communication on the UL. Both the reception component 1730 and the transmission component 1734 are configured to communicate through DL and UL, respectively, with the plurality of TRPs based on the activated joint DL and UL TCI states.

In one configuration, the reception component 1730 is configured to receive, from the TRP, DCI scheduling the communication through the DL and the UL with the plurality of TRPs. In one configuration, the scheduled communication through the DL and the UL with the plurality of TRPs at the reception component 1730 and the transmission component 1734 is associated with at least one of a PDCCH, a PDSCH, CSI-RS, or PRS for DL, and at least one of a PUCCH, a PUSCH, SRS, or a PRACH for UL. In one configuration, the scheduled communication through the DL and the UL with the plurality of TRPs at the reception component 1730 and the transmission component 1734 is through at least one of FDM, TDM, or SDM. In one configuration, the at least one set of activated joint DL and UL TCI states includes one set of activated joint DL and UL TCI states, and the activated one set of joint DL and UL TCI states are applied sequentially (by the joint DL/UL TCI state activation component 1740) to the scheduled communication through the DL and the UL with the plurality of TRPs. In one configuration, the activated at least one set of joint DL and UL TCI states are applied (by the joint DL/UL TCI state activation component 1740) to the scheduled communication through the DL and the UL with the plurality of TRPs based on a preconfiguration. In one configuration, the reception component 1730 is configured to receive, from a base station 102/180/404 associated with the TRP and the plurality of TRPs, a configuration indicating a mapping between the activated at least one set of joint DL and UL TCI states and the scheduled communication through the DL and the UL with the plurality of TRPs. In one configuration, the configuration is received through one of RRC signaling, a MAC-CE, or DCI. In one configuration, the MAC-CE includes a bitmap indicating at least one TCI codepoint. Each TCI codepoint of the at least one TCI codepoint includes a set of TCI state IDs corresponding to at least one of the activated joint DL and UL TCI states, the activated DL TCI states, or the activated UL TCI states. In one configuration, one TCI codepoint of the at least one TCI codepoint is associated with a set of default joint common DL and UL beams.

In one configuration, the activated at least one set of the joint DL and UL TCI states, the activated DL TCI states, or the activated UL TCI states includes a plurality of sets of activated joint DL and UL TCI states, activated DL TCI states, or activated UL TCI states. Each set corresponds to one TCI codepoint. In one configuration, the reception component 1730 is configured to receive, from the TRP, DCI scheduling the communication through the DL and the UL with the plurality of TRPs, and indicating a TCI codepoint for the scheduled communication. In such a configuration, the scheduled communication through DL and UL with the plurality of TRPs is based on the indicated TCI codepoint. In one configuration, the reception component 1730 is configured to receive, from the TRP, DCI indicating a TCI codepoint for DCI scheduled communication. In addition, the reception component 1730 is configured to receive at least one DCI scheduling the communication through the DL and the UL with the plurality of TRPs. The communication through the DL and the UL with the plurality of TRPs scheduled through the at least one DCI is based on the received TCI codepoint. In one configuration, the reception component 1730 is configured to receive, from the TRP, DCI scheduling the communication through the DL and the UL with the plurality of TRPs. The DCI excludes TCI codepoint information. In such a configuration, the scheduled communication through DL and UL with the plurality of TRPs is based on a default TCI codepoint indicated in the MAC-CE. The default TCI codepoint is associated with a set of default joint common DL and UL beams.

The apparatus may include additional components that perform each of the blocks of the algorithm in the aforementioned flowcharts of FIGS. 14-15. As such, each block in the aforementioned flowchart of FIGS. 14-15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the cellular baseband processor 1704, includes means for receiving, from a TRP, a MAC-CE activating at least one set of joint DL and UL TCI states for a plurality of TRPs. Each activated joint DL and UL TCI state indicates a common beam for communication in DL and UL. The apparatus 1702, and in particular the cellular baseband processor 1704, further includes means for communicating through DL and UL with the plurality of TRPs based on the activated joint DL and UL TCI states.

In one configuration, the apparatus 1702, and in particular the cellular baseband processor 1704, further includes means for receiving, from the TRP, DCI scheduling the communication through the DL and the UL with the plurality of TRPs. In one configuration, the scheduled communication through the DL and the UL with the plurality of TRPs is associated with at least one of a PDCCH, a PDSCH, CSI-RS, or PRS for DL, and at least one of a PUCCH, a PUSCH, SRS, or a PRACH for UL. In one configuration, the scheduled communication through the DL and the UL with the plurality of TRPs is through at least one of FDM, TDM, or SDM. In one configuration, the at least one set of activated joint DL and UL TCI states includes one set of activated joint DL and UL TCI states, and the activated one set of joint DL and UL TCI states are applied sequentially to the scheduled communication through the DL and the UL with the plurality of TRPs. In one configuration, the activated at least one set of joint DL and UL TCI states are applied to the scheduled communication through the DL and the UL with the plurality of TRPs based on a preconfiguration. In one configuration, the apparatus 1702, and in particular the cellular baseband processor 1704, further includes means for receiving, from a base station associated with the TRP and the plurality of TRPs, a configuration indicating a mapping between the activated at least one set of joint DL and UL TCI states and the scheduled communication through the DL and the UL with the plurality of TRPs. In one configuration, the configuration is received through one of RRC signaling, a MAC-CE, or DCI. In one configuration, the MAC-CE includes a bitmap indicating at least one TCI codepoint. Each TCI codepoint of the at least one TCI codepoint includes a set of TCI state IDs corresponding to at least one of the activated joint DL and UL TCI states, the activated DL TCI states, or the activated UL TCI states. In one configuration, one TCI codepoint of the at least one TCI codepoint is associated with a set of default joint common DL and UL beams. In one configuration, the activated at least one set of the joint DL and UL TCI states, the activated DL TCI states, or the activated UL TCI states includes a plurality of sets of activated joint DL and UL TCI states, activated DL TCI states, or activated UL TCI states. Each set corresponds to one TCI codepoint. In one configuration, the apparatus 1702, and in particular the cellular baseband processor 1704, further includes means for receiving, from the TRP, DCI scheduling the communication through the DL and the UL with the plurality of TRPs, and indicating a TCI codepoint for the scheduled communication. The scheduled communication through DL and UL with the plurality of TRPs is based on the indicated TCI codepoint. In one configuration, the apparatus 1702, and in particular the cellular baseband processor 1704, further includes means for receiving, from the TRP, DCI indicating a TCI codepoint for DCI scheduled communication, and means for receiving at least one DCI scheduling the communication through the DL and the UL with the plurality of TRPs. The communication through the DL and the UL with the plurality of TRPs scheduled through the at least one DCI is based on the received TCI codepoint. In one configuration, the apparatus 1702, and in particular the cellular baseband processor 1704, further includes means for receiving, from the TRP, DCI scheduling the communication through the DL and the UL with the plurality of TRPs. The DCI excludes TCI codepoint information. The scheduled communication through DL and UL with the plurality of TRPs is based on a default TCI codepoint indicated in the MAC-CE. The default TCI codepoint is associated with a set of default joint common DL and UL beams.

The aforementioned means may be one or more of the aforementioned components of the apparatus 1702/cellular baseband processor 1704 configured to perform the functions recited by the aforementioned means. As described supra, the apparatus 1702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

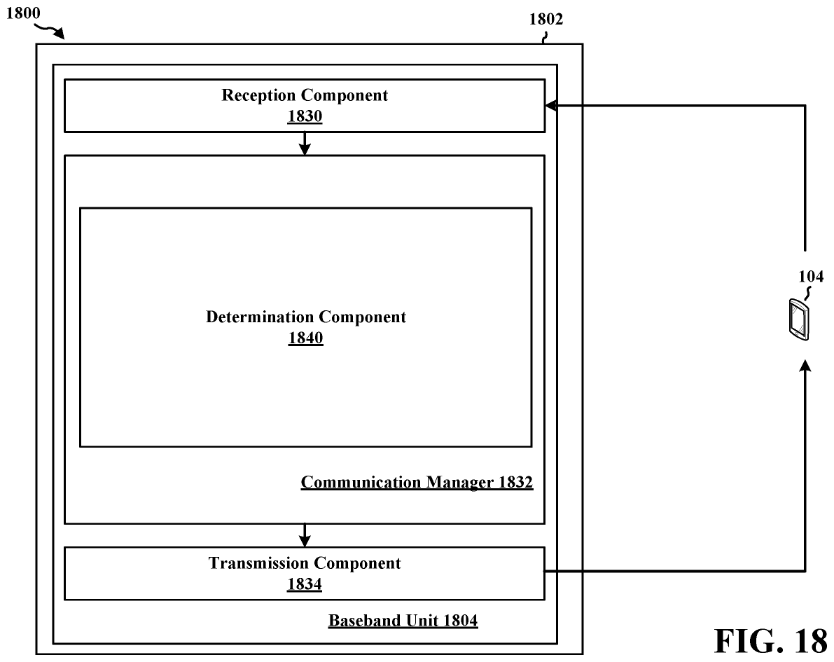

FIG. 18 is a diagram 1800 illustrating an example of a hardware implementation for an apparatus 1802. The apparatus 1802 is a base station and includes a baseband unit 1804. The baseband unit 1804 may communicate through a cellular RF transceiver with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the BS 310 and may include the memory 376 and/or at least one of the TX processor 316, the RX processor 370, and the controller/processor 375.

The communication manager 1832 includes a determination component 1840 that is configured to transmit, to a user equipment (UE), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL, e.g., as described in connection with step 1602 above. Determination component 1840 may also be configured to communicate through DL and UL with the UE based on the activated joint DL and UL TCI states, the activated DL TCI states, or the activated UL TCI states, e.g., as described in connection with step 1604 above.

The apparatus may include additional components that perform each of the blocks of the algorithm in the aforementioned flowchart of FIG. 16. As such, each block in the aforementioned flowchart of FIG. 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, includes means for transmitting, to a user equipment (UE), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL. The apparatus 1802 may also include means for communicating through DL and UL with the UE based on the activated joint DL and UL TCI states, the activated DL TCI states, or the activated UL TCI states. The aforementioned means may be one or more of the aforementioned components of the apparatus 1802 configured to perform the functions recited by the aforementioned means. As described supra, the apparatus 1802 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to: receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs; and communicate with the TRP through DL and UL scheduled through one or more CORESETs of the set of CORESETs associated with the CORESET pool ID based on the activated joint DL and UL TCI states, the activated DL TCI states, or the activated UL TCI states.

Aspect 2 is the apparatus of aspect 1, where the MAC-CE includes a bitmap indicating the CORESET pool ID and which of the configured joint DL and UL TCI states, the configured DL TCI states, or the configured UL TCI states are activated in association with the CORESET pool ID.

Aspect 3 is the apparatus of any of aspects 1 and 2, where each of the activated joint DL and UL TCI states, the activated DL TCI states, or the activated UL TCI states is associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL.

Aspect 4 is the apparatus of any of aspects 1 to 3, where each of the activated joint DL and UL TCI states, the activated DL TCI states, or the activated UL TCI states is associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID.

Aspect 5 is the apparatus of any of aspects 1 to 4, where the at least one processor is further configured to: receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states and indicating which of the at least one of the PUCCH, the PUSCH, the SRS, or the PRACH for UL that is scheduled by a CORESET associated with the CORESET pool ID is applicable to each of the activated joint DL and UL TCI states.

Aspect 6 is the apparatus of any of aspects 1 to 5, where the configuration is received through at least one of radio resource control (RRC) signaling, the MAC-CE, or downlink control information (DCI).

Aspect 7 is the apparatus of any of aspects 1 to 6, where the at least one processor is further configured to: receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID.

Aspect 8 is the apparatus of any of aspects 1 to 7, where the joint DL and UL TCI states, the DL TCI states, or the UL TCI states activated in the MAC-CE are mapped with sequential indexes to the TCI codepoint, the TCI codepoint being associated with the CORESET pool ID.

Aspect 9 is the apparatus of any of aspects 1 to 8, where the received DCI schedules the communication through DL or UL, and the communication through DL or UL scheduled through the DCI is based on the one of the activated joint DL and UL TCI states, the activated DL TCI states, or the activated UL TCI states corresponding to the index of the TCI codepoint indicated through the DCI.

Aspect 10 is the apparatus of any of aspects 1 to 9, where the at least one processor is further configured to: determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID.

Aspect 11 is the apparatus of any of aspects 1 to 10, where the DL resources and UL resources for the communication are preconfigured or predetermined.

Aspect 12 is the apparatus of any of aspects 1 to 11, where the at least one processor is further configured to: receive an indication of the DL resources and the UL resources for the communication scheduled by the one or more CORESETs associated with the CORESET pool ID, where the DL resources and the UL resources for the communication scheduled by the one or more CORESETs associated with the CORESET pool ID are determined based on the received indication.

Aspect 13 is the apparatus of any of aspects 1 to 12, where the indication is received through one of radio resource control (RRC) signaling, the MAC-CE, or the DCI.

Aspect 14 is the apparatus of any of aspects 1 to 13, further including a transceiver coupled to the at least one processor.

Aspect 15 is a method of wireless communication for implementing any of aspects 1 to 14.

Aspect 16 is an apparatus for wireless communication including means for implementing any of aspects 1 to 14.

Aspect 17 is a computer-readable medium storing computer executable code, where the code when executed by a processor causes the processor to implement any of aspects 1 to 14.

Aspect 18 is an apparatus for wireless communication at a TRP including at least one processor coupled to a memory and configured to: receive, from a transmission reception point (TRP), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL; and communicate through DL and UL with the plurality of TRPs based on the activated joint DL and UL TCI states, the activated DL TCI states, or the activated UL TCI states.

Aspect 19 is the apparatus of aspect 18, where the at least one processor is further configured to: receive, from the TRP, downlink control information (DCI) scheduling the communication through the DL and the UL with the plurality of TRPs.

Aspect 20 is the apparatus of any of aspects 18 and 19, where the scheduled communication through the DL and the UL with the plurality of TRPs is associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), a physical uplink shared channel (PUSCH), sounding reference signals (SRS), or a physical random access channel (PRACH) for UL.

Aspect 21 is the apparatus of any of aspects 18 to 20, where the scheduled communication through the DL and the UL with the plurality of TRPs is through at least one of frequency division multiplexing (FDM), time division multiplexing (TDM), or spatial division multiplexing (SDM).

Aspect 22 is the apparatus of any of aspects 18 to 21, where the at least one set of activated joint DL and UL TCI states includes one set of activated joint DL and UL TCI states, and the activated one set of joint DL and UL TCI states are applied sequentially to the scheduled communication through the DL and the UL with the plurality of TRPs.

Aspect 23 is the apparatus of any of aspects 18 to 22, where the activated at least one set of joint DL and UL TCI states are applied to the scheduled communication through the DL and the UL with the plurality of TRPs based on a preconfiguration.

Aspect 24 is the apparatus of any of aspects 18 to 23, where the at least one processor is further configured to: receive, from a base station associated with the TRP and the plurality of TRPs, a configuration indicating a mapping between the activated at least one set of joint DL and UL TCI states and the scheduled communication through the DL and the UL with the plurality of TRPs.

Aspect 25 is the apparatus of any of aspects 18 to 24, where the configuration is received through one of radio resource control (RRC) signaling, the MAC-CE, or the DCI.

Aspect 26 is the apparatus of any of aspects 18 to 25, where the MAC-CE includes a bitmap indicating at least one TCI codepoint, each TCI codepoint of the at least one TCI codepoint including a set of TCI state identifiers (IDs) corresponding to at least one of the activated joint DL and UL TCI states, the activated DL TCI states, or the activated UL TCI states.

Aspect 27 is the apparatus of any of aspects 18 to 26, where one TCI codepoint of the at least one TCI codepoint is associated with a set of default joint common DL and UL beams.

Aspect 28 is the apparatus of any of aspects 18 to 27, where the activated at least one set of the joint DL and UL TCI states, the activated DL TCI states, or the activated UL TCI states includes a plurality of sets of activated joint DL and UL TCI states, activated DL TCI states, or activated UL TCI states each set corresponding to one TCI codepoint.

Aspect 29 is the apparatus of any of aspects 18 to 28, where the at least one processor is further configured to: receive, from the TRP, downlink control information (DCI) scheduling the communication through the DL and the UL with the plurality of TRPs, and indicating a TCI codepoint for the scheduled communication, where the scheduled communication through DL and UL with the plurality of TRPs is based on the indicated TCI codepoint.

Aspect 30 is the apparatus of any of aspects 18 to 29, further including a transceiver coupled to the at least one processor, where the at least one processor is further configured to: receive, from the TRP, downlink control information (DCI) indicating a TCI codepoint for DCI scheduled communication; and receive at least one DCI scheduling the communication through the DL and the UL with the plurality of TRPs, the communication through the DL and the UL with the plurality of TRPs scheduled through the at least one DCI being based on the received TCI codepoint.

Aspect 31 is the apparatus of any of aspects 18 to 30, where the at least one processor is further configured to: receive, from the TRP, downlink control information (DCI) scheduling the communication through the DL and the UL with the plurality of TRPs, the DCI excluding TCI codepoint information, where the scheduled communication through DL and UL with the plurality of TRPs is based on a default TCI codepoint indicated in the MAC-CE, the default TCI codepoint being associated with a set of default joint common DL and UL beams.

Aspect 32 is a method of wireless communication for implementing any of aspects 18 to 31.

Aspect 33 is an apparatus for wireless communication including means for implementing any of aspects 18 to 31.

Aspect 34 is a computer-readable medium storing computer executable code, where the code when executed by a processor causes the processor to implement any of aspects 18 to 31.

What is claimed is:

1. An apparatus for wireless communication at a user equipment (UE), comprising:
a memory; and
at least one processor coupled to the memory and configured to:
receive, from a transmission reception point (TRP), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs; and
communicate with the TRP through DL and UL scheduled through one or more CORESETs of the set of CORESETs associated with the CORESET pool ID based on the activated joint DL and UL TCI states, the activated DL TCI states, or the activated UL TCI states.

2. The apparatus of claim 1, wherein the MAC-CE comprises a bitmap indicating the CORESET pool ID and which of the configured joint DL and UL TCI states, the configured DL TCI states, or the configured UL TCI states are activated in association with the CORESET pool ID.

3. The apparatus of claim 1, wherein each of the activated joint DL and UL TCI states, the activated DL TCI states, or the activated UL TCI states is associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), physical uplink shared channel (PUSCH), sounding reference signals (SRS), or a physical random access channel (PRACH) for UL.

4. The apparatus of claim 3, wherein each of the activated joint DL and UL TCI states, the activated DL TCI states, or the activated UL TCI states is associated with the at least one of the PDCCH, the PDSCH, the CSI-RS, or the PRS for DL that is scheduled by a CORESET associated with the CORESET pool ID, and is associated with the at least one of the PUCCH, the PUSCH, the SRS, or the PRACH for UL that is scheduled by a CORESET associated with the CORESET pool ID.

5. The apparatus of claim 3, wherein the at least one processor is further configured to:
receive a configuration indicating which of the at least one of the PDCCH, the PDSCH, the CSI-RS, or the PRS for DL that is scheduled by a CORESET associated with the CORESET pool ID is applicable to each of the activated joint DL and UL TCI states, the activated DL TCI states, or the activated UL TCI states, and indicating which of the at least one of the PUCCH, the PUSCH, the SRS, or the PRACH for UL that is scheduled by a CORESET associated with the CORESET pool ID is applicable to each of the activated joint DL and UL TCI states.

6. The apparatus of claim 5, wherein the configuration is received through at least one of radio resource control (RRC) signaling, the MAC-CE, or downlink control information (DCI).

7. The apparatus of claim 1, wherein the at least one processor is further configured to:
receive downlink control information (DCI) in a CORESET associated with the CORESET pool ID, the DCI indicating an index of a TCI codepoint, the index corresponding to one of the activated joint DL and UL TCI states, the activated DL TCI states, or the activated UL TCI states associated with the CORESET pool ID.

8. The apparatus of claim 7, wherein the joint DL and UL TCI states, the DL TCI states, or the UL TCI states activated in the MAC-CE are mapped with sequential indexes to the TCI codepoint, the TCI codepoint being associated with the CORESET pool ID.

9. The apparatus of claim 7, wherein the received DCI schedules the communication through DL or UL, and the communication through DL or UL scheduled through the DCI is based on the one of the activated joint DL and UL TCI states, the activated DL TCI states, or the activated UL TCI states corresponding to the index of the TCI codepoint indicated through the DCI.

10. The apparatus of claim 7, wherein the at least one processor is further configured to:
determine DL resources and UL resources for the communication to which the one of the activated joint DL and UL TCI states, the activated DL TCI states, or the activated UL TCI states corresponding to the index of the TCI codepoint indicated through the DCI applies, the determined DL resources and UL resources being scheduled by the one or more CORESETs associated with the CORESET pool ID.

11. The apparatus of claim 10, wherein the DL resources and UL resources for the communication are preconfigured or predetermined.

12. The apparatus of claim 10, wherein the at least one processor is further configured to:
receive an indication of the DL resources and the UL resources for the communication scheduled by the one or more CORESETs associated with the CORESET pool ID, wherein the DL resources and the UL resources for the communication scheduled by the one or more CORESETs associated with the CORESET pool ID are determined based on the received indication.

13. The apparatus of claim 12, wherein the indication is received through one of radio resource control (RRC) signaling, the MAC-CE, or the DCI.

14. The apparatus of claim 1, further comprising a transceiver coupled to the at least one processor.

15. An apparatus for wireless communication at a user equipment (UE), comprising:
a memory; and
at least one processor coupled to the memory and configured to:
receive, from a transmission reception point (TRP), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL; and
communicate through DL and UL with the plurality of TRPs based on the activated joint DL and UL TCI states, the activated DL TCI states, or the activated UL TCI states.

16. The apparatus of claim 15, wherein the at least one processor is further configured to:
receive, from the TRP, downlink control information (DCI) scheduling the communication through the DL and the UL with the plurality of TRPs.

17. The apparatus of claim 16, wherein the scheduled communication through the DL and the UL with the plurality of TRPs is associated with at least one of a physical downlink control channel (PDCCH), a physical downlink shared channel (PDSCH), channel state information (CSI) reference signals (RS) (CSI-RS), or positioning RS (PRS) for DL, and at least one of a physical uplink control channel (PUCCH), a physical uplink shared channel (PUSCH), sounding reference signals (SRS), or a physical random access channel (PRACH) for UL.

18. The apparatus of claim 16, wherein the scheduled communication through the DL and the UL with the plurality of TRPs is through at least one of frequency division multiplexing (FDM), time division multiplexing (TDM), or spatial division multiplexing (SDM).

19. The apparatus of claim 16, wherein the at least one set of activated joint DL and UL TCI states comprises one set of activated joint DL and UL TCI states, and the activated one set of joint DL and UL TCI states are applied sequentially to the scheduled communication through the DL and the UL with the plurality of TRPs.

20. The apparatus of claim 16, wherein the activated at least one set of joint DL and UL TCI states are applied to the scheduled communication through the DL and the UL with the plurality of TRPs based on a preconfiguration.

21. The apparatus of claim 16, wherein the at least one processor is further configured to:
receive, from a base station associated with the TRP and the plurality of TRPs, a configuration indicating a mapping between the activated at least one set of joint DL and UL TCI states and the scheduled communication through the DL and the UL with the plurality of TRPs.

22. The apparatus of claim 21, wherein the configuration is received through one of radio resource control (RRC) signaling, the MAC-CE, or the DCI.

23. The apparatus of claim 15, wherein the MAC-CE comprises a bitmap indicating at least one TCI codepoint, each TCI codepoint of the at least one TCI codepoint including a set of TCI state identifiers (IDs) corresponding to at least one of the activated joint DL and UL TCI states, the activated DL TCI states, or the activated UL TCI states.

24. The apparatus of claim 23, wherein one TCI codepoint of the at least one TCI codepoint is associated with a set of default joint common DL and UL beams.

25. The apparatus of claim 15, wherein the activated at least one set of the joint DL and UL TCI states, the activated DL TCI states, or the activated UL TCI states comprises a plurality of sets of activated joint DL and UL TCI states, activated DL TCI states, or activated UL TCI states, each set corresponding to one TCI codepoint.

26. The apparatus of claim 25, wherein the at least one processor is further configured to:
receive, from the TRP, downlink control information (DCI) scheduling the communication through the DL and the UL with the plurality of TRPs, and indicating a TCI codepoint for the scheduled communication, wherein the scheduled communication through DL and UL with the plurality of TRPs is based on the indicated TCI codepoint.

27. The apparatus of claim 25, further comprising a transceiver coupled to the at least one processor, wherein the at least one processor is further configured to:
receive, from the TRP, downlink control information (DCI) indicating a TCI codepoint for DCI scheduled communication; and
receive at least one DCI scheduling the communication through the DL and the UL with the plurality of TRPs, the communication through the DL and the UL with the plurality of TRPs scheduled through the at least one DCI being based on the received TCI codepoint.

28. The apparatus of claim 25, wherein the at least one processor is further configured to:
receive, from the TRP, downlink control information (DCI) scheduling the communication through the DL and the UL with the plurality of TRPs, the DCI excluding TCI codepoint information, wherein the scheduled communication through DL and UL with the plurality of TRPs is based on a default TCI codepoint indicated in the MAC-CE, the default TCI codepoint being associated with a set of default joint common DL and UL beams.

29. An apparatus for wireless communication at a transmission reception point (TRP), comprising:
a memory; and
at least one processor coupled to the memory and configured to:
transmit, to a user equipment (UE), a media access control (MAC) control element (CE) (MAC-CE) activating a subset of configured joint downlink (DL) and uplink (UL) transmission configuration indicator (TCI) states, configured DL TCI states, or configured UL TCI states, each of the activated joint DL and UL TCI states indicating a common beam for communication in DL and UL, each of the activated DL TCI states indicating a beam for communication in DL, each of the activated UL TCI states indicating a beam for communication in UL, the MAC-CE indicating a control resource set (CORESET) pool identifier (ID) associated with a set of CORESETs; and
communicate with the UE through DL and UL scheduled through one or more CORESETs of the set of CORESETs associated with the CORESET pool ID based on the activated joint DL and UL TCI states, the activated DL TCI states, or the activated UL TCI states.

30. An apparatus for wireless communication at a transmission reception point (TRP), comprising:
a memory; and
at least one processor coupled to the memory and configured to:
transmit, to a user equipment (UE), a media access control (MAC) control element (CE) (MAC-CE) activating at least one set of joint downlink (DL) and uplink (UL) transmission configuration indicator (TCI) states, DL TCI states, or UL TCI states for a plurality of TRPs, each of the activated joint DL and UL TCI states indicating a common beam for communication in DL and UL, each of the activated DL TCI states indicating a beam for communication in DL, each of the activated UL TCI states indicating a beam for communication in UL; and
communicate through DL and UL with the UE based on the activated joint DL and UL TCI states, the activated DL TCI states, or the activated UL TCI states.
